(19) United States
(12) Patent Application Publication
(10) Pub. No.: US 2025/0379689 A1
(43) Pub. Date: Dec. 11, 2025

(54) METHOD AND APPARATUS FOR PUSCH OR PDSCH SCHEDULING ON A PLURALITY OF CELLS

(71) Applicant: HARFANG IP INVESTMENT CORPORATION, ROUND ROCK, TX (US)

(72) Inventor: Sushil KUMAR, Haryana (IN)

(73) Assignee: HARFANG IP INVESTMENT CORPORATION, ROUND ROCK, TX (US)

(21) Appl. No.: 18/876,499

(22) PCT Filed: Jun. 19, 2023
(86) PCT No.: PCT/US2023/025666

§ 371 Date: Dec. 18, 2024

(30) Foreign Application Priority Data
Jun. 18, 2022 (IN) 202211034986

(51) Int. Cl. H04L 5/00; H04L 1/1812

(52) U.S. Cl. CPC H04L 5/0044; H04L 1/1812; H04L 5/0005

(57) ABSTRACT

A method, an apparatus, and a computer readable medium for storing instructions are described for a user terminal and a base station for PUSCH or PDSCH scheduling on a plurality of cells. The method performed by a user equipment comprises receiving a downlink control information (DCI) including scheduling information associated with a respective PUSCH or a respective PDSCH for a subset of cells of a plurality of cells, each of the plurality of cells associated with a respective cell index; wherein the DCI comprises: a common field including information indicative of a first cell index associated with a first cell of the subset of cells and a second cell index associated with a second cell of the subset of cells, wherein either (i) the smallest of the first cell index or the second cell index is greater than smallest cell index of the plurality of the cells, or (ii) the first cell index and the second cell index are not consecutive cell indices; a first independent field including first information of a first category of information; and a second independent field including second information of the first category of information; wherein the second independent field follows the first independent field in the DCI; wherein the first information is applicable to the cell having the smallest cell index of the subset of cells; and wherein the second information is applicable to the cell having the second smallest cell index of the subset of cells; and transmitting the respective PUSCH on the subset of cells or receiving the respective PDSCH on the subset of cells based on the received DCI.

### CROSS REFERENCE TO RELATED APPLICATIONS

This application claims the benefit of India application No. 202211034986, filed Jun. 18, 2022, the contents of which are incorporated by reference as if fully set forth.

### BACKGROUND

One of the finalized work items for 3GPP release 18 is “Multi-carrier enhancements for NR”. The description of the problem statement, and the objective of “Multi-carrier enhancements for NR” is described in RP-220834, 3GPP TSG RAN Meeting #95e, Electronic Meeting, Mar. 17-23, 2022, in section 3 and 4 as reproduced below.

### 3. Justification

NR supports a wide range of spectrum in different frequency ranges. It is expected that there will be increasing availability of spectrum in the market for 5G Advanced, possibly due to re-farming from the bands originally used for previous cellular generation networks. Especially for low frequency FR1 bands, the available spectrum blocks tend to be more fragmented and scattered with narrower bandwidth. For FR2 bands and some FR1 bands, the available spectrum can be wider such that intra-band multi-carrier operation is necessary. To meet different spectrum needs, it is important to ensure that these scattered spectrum bands or wider bandwidth spectrum can be utilized in a more spectral/power efficient and flexible manner, thus providing higher throughput and decent coverage in the network.

One motivation is to increase flexibility and spectral/power efficiency on scheduling data over multiple cells including intra-band cells and inter-band cells. The current scheduling mechanism only allows scheduling of single cell PUSCH/PDSCH per scheduling DCI. With more available scattered spectrum bands or wider bandwidth spectrum, the need of simultaneous scheduling of multiple cells is expected to be increasing. To reduce the control overhead, it is beneficial to extend from single-cell scheduling to multi-cell PUSCH/PDSCH scheduling with a single scheduling DCI. Meanwhile, the trade-off between overhead saving and scheduling restriction has to be taken into account.

For multi-carrier UL operation, there are some limitations of current specification, e.g., 2TX UE can be configured with at most 2 UL bands, which only can be changed by RRC reconfiguration, and UL Tx switching can be only performed between 2 UL bands for 2Tx UE. Dynamically selecting carriers with UL Tx switching e.g., based on the data traffic, TDD DL/UL configuration, bandwidths, and channel conditions of each band, instead of RRC-based cell(s) reconfiguration, may potentially lead to higher UL data rate, spectrum utilization and UL capacity.

### 4. Objective

4.1 Objective of SI or Core part WI or Testing part WI

1. Specify a solution for multi-cell PUSCH/PDSCH scheduling (one PDSCH/PUSCH per cell) with a single DCI[RAN1]
Identify the maximum number of cells that can be scheduled simultaneously
Consider both intra-band and inter-band CA operation.
Consider both FR1 and FR2
The single DCI shall be optimized for 3 or more cells for the multi-cell PUSCH/PDSCH scheduling.

2. Study and if necessary specify following enhancements for multi-carrier UL operation [RAN1, RAN2, RAN4]
UL Tx switching schemes across up to 3 or 4 bands with restriction of up to 2 Tx simultaneous transmission for FR1 UEs, including mechanisms to enable more configured UL bands than its simultaneous transmission capability and to support dynamic Tx carrier switching across the configured bands for both single TAG and multiple TAGs configurations (RAN1, RAN4)
   UE capability and RRC configuration related signalling (RAN2).
   Note: strive for RAN1/2 design agnostic with the number of bands, i.e., common design between 3 and 4 bands
   Note: no additional TAG is introduced for UL transmission on a carrier without corresponding DL carrier.
   Note: this objective does not target to extend the SUL framework to support more than 1 SUL for 1 NUL.
Switching time and other RF aspects, and RRM requirements for above UL Tx switching schemes across up to 3 or 4 bands (RAN4)
   Note: Prioritize UL Tx switching across up to 3 bands is to be addressed first and then that for up to 4 bands can also be addressed

### SUMMARY

In an embodiment, a method of wireless communication, performed by a UE, comprising receiving a downlink control information (DCI) including scheduling information associated with a respective PUSCH or a respective PDSCH for a subset of cells of a plurality of cells, each of the plurality of cells associated with a respective cell index. The DCI comprises a common field including information indicative of a first cell index associated with a first cell of the subset of cells and a second cell index associated with a second cell of the subset of cells, wherein either (i) the smallest of the first cell index or the second cell index is greater than smallest cell index of the plurality of the cells, or (ii) the first cell index and the second cell index are not consecutive cell indices. The DCI further comprises a first independent field including first information of a first category of information and a second independent field including second information of the first category of information, wherein the second independent field follows the first independent field in the DCI, wherein the first information is applicable to the cell having the smallest cell index of the subset of cells, and wherein the second information is applicable to the cell having the second smallest cell index of the subset of cells, and transmitting the respective PUSCH on the subset of cells or receiving the respective PDSCH on the subset of cells based on the received DCI.

In an embodiment, the received DCI further comprises a third independent field including third information of a second category of information, and a fourth independent field including fourth information of the second category of information. The third independent field follows the second independent field in the DCI. The fourth independent field follows the third independent field in the DCI. The third information is applicable to the cell having the smallest cell index of the subset of cells and the fourth information is applicable to the cell having the second smallest cell index of the subset of cells.

In an embodiment, the received DCI further comprises a third independent field including third information of a second category of information and a fourth independent field including fourth information of the second category of information. The third independent field follows the first independent field in the DCI. The second independent field follows the third independent field in the DCI. The fourth independent field follows the second independent field in DCI. The third information is applicable to the cell having the smallest cell index of the subset of cells and the fourth information is applicable to the cell having the second smallest cell index of the subset of cells.

In an embodiment, the first common field in the received DCI further includes information indicative of a third cell index associated with a third cell of the subset of cells wherein the second cell index and the third cell index are consecutive, and the DCI further comprises a third independent field including third information of the first category of information. The third independent field follows the second independent field in the DCI and the third information is applicable to the cell having the third smallest cell index of the subset of cells.

In an embodiment, the received DCI further comprises a second common field including information applicable to the subset of cells of the plurality of cells. The information applicable to the subset of the plurality of cells includes one of DCI format information, downlink assignment index information, TPC for scheduled PUCCH information, PUCCH resource indicator information, or PDSCH-to-HARQ timing indicator information. When the information applicable to the subset of the plurality of cells includes DCI format information indicating uplink scheduling, the DCI further comprises a third common field carrying a TPC for scheduled PUCCH information and a fourth common field carrying a PUCCH resource indicator information.

In an embodiment, the first category of information in the received DCI includes one of new data indicator information, redundancy version information, modulation and coding scheme information, frequency domain resource assignment information, time domain resource assignment information, or HARQ process number information.

In an embodiment, the DCI is received on a cell other than one of the subset of cells.

In an embodiment, the DCI is received on the cell having the smallest cell index of the subset of cells.

In an embodiment, the method of wireless communication, performed by a UE, further comprising receiving a RRC signaling. The subset of cells is represented by two or more bits in the RRC signaling and the RRC signaling indicates a relationship between a value of the two or more bits and the subset of cells. The RRC signaling includes a Cell Group ID indicating the plurality of cells and further includes the respective cell indices for the plurality of cells. The DCI is received on a cell of the plurality of cells and the RRC signaling further includes the cell index of the cell of the plurality of cells upon which the DCI is received. The group of cells indicated by the Cell Group ID is a PUCCH cell group. The RRC signaling is included in a ServingCellConfig message.

In an embodiment, an apparatus comprising a processor or a plurality of processors, a transceiver or a plurality of transceivers configured to receive, from a base station, a downlink control information (DCI) including scheduling information associated with a respective PUSCH or a respective PDSCH for a subset of cells of a plurality of cells using the processor or the plurality of processors, each of the plurality of cells associated with a respective cell index. The DCI comprises a common field including information indicative of a first cell index associated with a first cell of the subset of cells and a second cell index associated with a second cell of the subset of cells, wherein either (i) the smallest of the first cell index or the second cell index is greater than smallest cell index of the plurality of the cells, or (ii) the first cell index and the second cell index are not consecutive cell indices. The DCI further comprises a first independent field including first information of a first category of information and a second independent field including second information of the first category of information, wherein the second independent field follows the first independent field in the DCI, wherein the first information is applicable to the cell having the smallest cell index of the subset of cells, and wherein the second information is applicable to the cell having the second smallest cell index of the subset of cells, and the transceiver or the plurality of transceivers configured to transmit the respective PUSCH on the subset of cells or receive the respective PDSCH on the subset of cells based on the received DCI.

In an embodiment, the apparatus further comprises the transceiver or the plurality of transceivers configured to receive a RRC signaling. The subset of cells is represented by two or more bits in the RRC signaling and the RRC signaling indicates a relationship between a value of the two or more bits and the subset of cells. The RRC signaling includes a Cell Group ID indicating the plurality of cells and further includes the respective cell indices for the plurality of cells. The DCI is received on a cell of the plurality of cells and the RRC signaling further includes the cell index of the cell of the plurality of cells upon which the DCI is received. The group of cells indicated by the Cell Group ID is a PUCCH cell group. The RRC signaling is included in a ServingCellConfig message.

In an embodiment, a method of wireless communication, performed by a base station, comprising transmitting a downlink control information (DCI) including scheduling information associated with a respective PUSCH or a respective PDSCH for a subset of cells of a plurality of cells, each of the plurality of cells associated with a respective cell index. The DCI comprises a common field including information indicative of a first cell index associated with a first cell of the subset of cells and a second cell index associated with a second cell of the subset of cells, wherein either (i) the smallest of the first cell index or the second cell index is greater than smallest cell index of the plurality of the cells, or (ii) the first cell index and the second cell index are not consecutive cell indices. The DCI further comprises a first independent field including first information of a first category of information and a second independent field including second information of the first category of information, wherein the second independent field follows the first independent field in the DCI, wherein the first information is applicable to the cell having the smallest cell index of the subset of cells, and wherein the second information is applicable to the cell having the second smallest cell index of the subset of cells, and receiving the respective PUSCH on the subset of cells or transmitting the respective PDSCH on the subset of cells based on the transmitted DCI.

In an embodiment, the transmitted DCI further comprises a third independent field including third information of a second category of information, and a fourth independent field including fourth information of the second category of information. The third independent field follows the second independent field in the DCI. The fourth independent field follows the third independent field in the DCI. The third information is applicable to the cell having the smallest cell index of the subset of cells and the fourth information is applicable to the cell having the second smallest cell index of the subset of cells.

In an embodiment, the transmitted DCI further comprises a third independent field including third information of a second category of information and a fourth independent field including fourth information of the second category of information. The third independent field follows the first independent field in the DCI. The second independent field follows the third independent field in the DCI. The fourth independent field follows the second independent field in DCI. The third information is applicable to the cell having the smallest cell index of the subset of cells and the fourth information is applicable to the cell having the second smallest cell index of the subset of cells.

In an embodiment, the first common field in the transmitted DCI further includes information indicative of a third cell index associated with a third cell of the subset of cells wherein the second cell index and the third cell index are consecutive, and the DCI further comprises a third independent field including third information of the first category of information. The third independent field follows the second independent field in the DCI and the third information is applicable to the scheduled cell having the third smallest cell index of the subset of cells.

In an embodiment, the transmitted DCI further comprises a second common field including information applicable to the subset of cells of the plurality of cells. The information applicable to the subset of the plurality of cells includes one of DCI format information, downlink assignment index information, TPC for scheduled PUCCH information, PUCCH resource indicator information, or PDSCH-to-HARQ timing indicator information. When the information applicable to the subset of the plurality of cells includes DCI format information indicating uplink scheduling, the DCI further comprises a third common field carrying a TPC for scheduled PUCCH information and a fourth common field carrying a PUCCH resource indicator information.

In an embodiment, the first category of information in the transmitted DCI includes one of new data indicator information, redundancy version information, modulation and coding scheme information, frequency domain resource assignment information, time domain resource assignment information, or HARQ process number information.

In an embodiment, the DCI is transmitted on a cell other than one of the subset of cells.

In an embodiment, the DCI is transmitted on the cell having the smallest cell index of the subset of cells.

In an embodiment, the method of wireless communication, performed by a base station, further comprising transmitting a RRC signaling. The subset of cells is represented by two or more bits in the RRC signaling and the RRC signaling indicates a relationship between a value of the two or more bits and the subset of cells. The RRC signaling includes a Cell Group ID indicating the plurality of cells and further includes the respective cell indices for the plurality of cells. The DCI is transmitted on a cell of the plurality of cells and the RRC signaling further includes the cell index of the cell of the plurality of cells upon which the DCI is transmitted. The group of cells indicated by the Cell Group ID is a PUCCH cell group. The RRC signaling is included in a ServingCellConfig message.

In an embodiment, an apparatus comprising a processor or a plurality of processors, a transceiver or a plurality of transceivers configured to transmit, to a UE, a downlink control information (DCI) including scheduling information associated with a respective PUSCH or a respective PDSCH for a subset of cells of a plurality of cells using the processor or the plurality of processors, each of the plurality of cells associated with a respective cell index. The DCI comprises a common field including information indicative of a first cell index associated with a first cell of the subset of cells and a second cell index associated with a second cell of the subset of cells, wherein either (i) the smallest of the first cell index or the second cell index is greater than smallest cell index of the plurality of the cells, or (ii) the first cell index and the second cell index are not consecutive cell indices. The DCI further comprises a first independent field including first information of a first category of information and a second independent field including second information of the first category of information, wherein the second independent field follows the first independent field in the DCI, wherein the first information is applicable to the cell having the smallest cell index of the subset of cells, and wherein the second information is applicable to the cell having the second smallest cell index of the subset of cells, and receiving the respective PUSCH on the subset of cells or transmitting the respective PDSCH on the subset of cells based on the transmitted DCI.

In an embodiment, the apparatus further comprises the transceiver or the plurality of transceivers configured to transmit a RRC signaling. The subset of cells is represented by two or more bits in the RRC signaling and the RRC signaling indicates a relationship between a value of the two or more bits and the subset of cells. The RRC signaling includes a Cell Group ID indicating the plurality of cells and further includes the respective cell indices for the plurality of cells. The DCI is transmitted on a cell of the plurality of cells and the RRC signaling further includes the cell index of the cell of the plurality of cells upon which the DCI is transmitted. The group of cells indicated by the Cell Group ID is a PUCCH cell group. The RRC signaling is included in a ServingCellConfig message.

In an embodiment, a method of wireless communication, performed by a UE, comprising receiving a RRC signaling for configuring a downlink control information (DCI) scheduling at least two cells of a plurality of cells for a respective PUSCH transmission or a respective PDSCH reception, wherein the RRC signaling comprises a Cell Group ID, whereby the Cell Group ID indicates a cell group containing a plurality of cells. The RRC signaling may further comprises one or more of the respective cell indices for the plurality of cells, a cell index of the cell of the plurality of cells upon which a DCI is configured to be received, or a set of co-scheduled cell indicator (CSCI) values. The set of co-scheduled cell indicator (CSCI) values comprises a plurality of CSCI values and each CSCI value is associated with one or more cells. The RRC signaling is received in a ServingCellConfig message(s). The cell group containing a plurality of cells is a PUCCH cell group, where one cell is allowed to be part of a one PUCCH cell group if there are multiple cell groups configured for the user equipment. The method further comprises receiving a DCI for scheduling a respective PUSCH or respective PDSCH for at least two cells of the plurality of cells, wherein the DCI comprises a CSCI value, and comparing the CSCI value received in the DCI with the CSCI values received in the RRC signaling and accordingly scheduling at least two cells of the plurality of cells for respective PUSCH transmission or respective PDSCH reception based on the CSCI value received in the DCI.

In an embodiment, an apparatus comprising a processor or a plurality of processors, a transceiver or a plurality of transceivers configured to receive, from a base station, a RRC signaling for configuring a downlink control information (DCI) scheduling at least two cells of a plurality of cells for a respective PUSCH transmission or a respective PDSCH reception, wherein the RRC signaling comprises a Cell Group ID, whereby the Cell Group ID indicates a cell group containing a plurality of cells. The RRC signaling may further comprises one or more of the respective cell indices for the plurality of cells, a cell index of the cell of the plurality of cells upon which a DCI is configured to be received, or a set of co-scheduled cell indicator (CSCI) values. The set of co-scheduled cell indicator (CSCI) values comprises a plurality of CSCI values and each CSCI value is associated with one or more cells. The RRC signaling is received in a ServingCellConfig message(s). The cell group containing a plurality of cells is a PUCCH cell group, where one cell is allowed to be part of a one PUCCH cell group if there are multiple cell groups configured for the user equipment. The apparatus further comprises the transceiver or the plurality of transceivers configured to receive a DCI for scheduling a respective PUSCH or respective PDSCH for at least two cells of the plurality of cells, wherein the DCI comprises a CSCI value, and the processor or the plurality of processors are further configured to compare the CSCI value received in the DCI with the CSCI values received in the RRC signaling and accordingly scheduling at least two cells of the plurality of cells for respective PUSCH transmission or respective PDSCH reception based on the CSCI value received in the DCI.

In an embodiment, a non-transitory computer-readable medium comprising instructions operable to cause a processor or a plurality of processors to receive, from a base station, a RRC signaling for configuring a downlink control information (DCI) scheduling at least two cells of a plurality of cells for a respective PUSCH transmission or a respective PDSCH reception, wherein the RRC signaling comprises a Cell Group ID, whereby the Cell Group ID indicates a cell group containing a plurality of cells. The RRC signaling may further comprises one or more of the respective cell indices for the plurality of cells, a cell index of the cell of the plurality of cells upon which a DCI is configured to be received, or a set of co-scheduled cell indicator (CSCI) values. The set of co-scheduled cell indicator (CSCI) values comprises a plurality of CSCI values and each CSCI value is associated with one or more cells. The RRC signaling is received in a ServingCellConfig message(s). The cell group containing a plurality of cells is a PUCCH cell group, where one cell is allowed to be part of a one PUCCH cell group if there are multiple cell groups configured for the user equipment. The non-transitory computer-readable medium further comprises instructions operable to cause a processor or a plurality of processors to receive a DCI for scheduling a respective PUSCH or respective PDSCH for at least two cells of the plurality of cells, wherein the DCI comprises a CSCI value, and compare the CSCI value received in the DCI with the CSCI values received in the RRC signaling and accordingly scheduling at least two cells of the plurality of cells for respective PUSCH transmission or respective PDSCH reception based on the CSCI value received in the DCI.

In an embodiment, a method of wireless communication, performed by a base station, comprising transmitting RRC signaling for configuring a downlink control information (DCI) scheduling at least two cells of a plurality of cells for a respective PUSCH or a respective PDSCH, wherein the RRC signaling comprises a Cell Group ID, whereby the Cell Group ID indicates a cell group containing a plurality of cells. The RRC signaling may further comprises one or more of the respective cell indices for the plurality of cells, a cell index of the cell of the plurality of cells upon which a DCI is configured to be transmitted, or a set of co-scheduled cell indicator (CSCI) values. The set of co-scheduled cell indicator (CSCI) values comprises a plurality of CSCI values and each CSCI value is associated with one or more cells. The RRC signaling is transmitted in a ServingCellConfig message(s). The cell group containing a plurality of cells is a PUCCH cell group, where one cell is allowed to be part of a one PUCCH cell group if there are multiple cell groups configured for the user equipment. The method further comprises transmitting a DCI for scheduling a respective PUSCH or respective PDSCH for at least two cells of the plurality of cells, wherein the DCI comprises a CSCI value, and scheduling at least two cells of the plurality of cells for respective PUSCH or respective PDSCH based on the CSCI value transmitted in the DCI.

In an embodiment, an apparatus comprising a processor or a plurality of processors, a transceiver or a plurality of transceivers configured to transmit, to a UE, a RRC signaling for configuring a downlink control information (DCI) scheduling at least two cells of a plurality of cells for a respective PUSCH or a respective PDSCH, wherein the RRC signaling comprises a Cell Group ID, whereby the Cell Group ID indicates a cell group containing a plurality of cells. The RRC signaling may further comprises one or more of the respective cell indices for the plurality of cells, a cell index of the cell of the plurality of cells upon which a DCI is configured to be transmitted, or a set of co-scheduled cell indicator (CSCI) values. The set of co-scheduled cell indicator (CSCI) values comprises a plurality of CSCI values and each CSCI value is associated with one or more cells. The RRC signaling are transmitted in a ServingCellConfig message(s). The cell group containing a plurality of cells is a PUCCH cell group, where one cell is allowed to be part of a one PUCCH cell group if there are multiple cell groups configured for the user equipment. The apparatus further comprises the transceiver or the plurality of transceivers configured to transmit a DCI for scheduling a respective PUSCH or respective PDSCH for at least two cells of the plurality of cells, wherein the DCI comprises a CSCI value, and the processor or the plurality of processors are further configured to schedule at least two cells of the plurality of cells for respective PUSCH or respective PDSCH based on the CSCI value transmitted in the DCI.

In an embodiment, a non-transitory computer-readable medium comprising instructions operable to cause a processor or a plurality of processors to transmit, to a UE, a RRC signaling for configuring a downlink control information (DCI) scheduling at least two cells of a plurality of cells for a respective PUSCH or a respective PDSCH, wherein the RRC signaling comprises a Cell Group ID, whereby the Cell Group ID indicates a cell group containing a plurality of cells. The RRC signaling may further comprises one or more of the respective cell indices for the plurality of cells, a cell index of the cell of the plurality of cells upon which a DCI is configured to be transmitted, or a set of co-scheduled cell indicator (CSCI) values. The set of co-scheduled cell indicator (CSCI) values comprises a plurality of CSCI values and each CSCI value is associated with one or more cells. The RRC signaling are transmitted in a ServingCellConfig message(s). The cell group containing a plurality of cells is a PUCCH cell group, where one cell is allowed to be part of a one PUCCH cell group if there are multiple cell groups configured for the user equipment. The non-transitory computer-readable medium further comprises instructions operable to cause a processor or a plurality of processors to transmit a DCI for scheduling a respective PUSCH or respective PDSCH for at least two cells of the plurality of cells, wherein the DCI comprises a CSCI value, and schedule at least two cells of the plurality of cells for respective PUSCH or respective PDSCH based on the CSCI value transmitted in the DCI.

### BRIEF DESCRIPTION OF THE DRAWINGS

FIG. 1 is an architecture of a wireless radio system according to an embodiment.

FIG. 2 is a diagram of a user plane protocol stack in a wireless radio system according to an embodiment.

FIG. 3 is a diagram of a control plane protocol stack in a wireless radio system according to an embodiment.

FIG. 4 is a block diagram of a user equipment according to an embodiment.

FIG. 5 is a block diagram of a base station according to an embodiment.

FIG. 6 is a flow diagram illustrating how a user equipment may be configured for a DCI scheduling a PUSCH or PDSCH per cell on each of a plurality of cells according to an embodiment.

FIG. 7 is a flow diagram illustrating how a base station may configure a user equipment for a DCI scheduling a PUSCH or PDSCH per cell on each of a plurality of cells according to an embodiment.

FIG. 8 is an illustration of a first embodiment related to scheduling configuration of the cells.

FIG. 9 is an illustration of a second embodiment related to scheduling configuration of the cells.

FIG. 10 is an illustration of a third embodiment related to scheduling configuration of the cells.

FIG. 11 is an illustration of a fourth embodiment related to scheduling configuration of the cells.

FIG. 12 is an illustration of a first embodiment related to configurations of DCI field format.

FIG. 13 is an illustration of a second embodiment related to configurations of DCI field format.

FIG. 14 is an illustration of a third embodiment related to configurations of DCI field format.

FIG. 15 is an illustration of a fourth embodiment related to configurations of DCI field format.

FIG. 16 is an illustration of a fifth embodiment related to configurations of DCI field format.

FIG. 17 is an illustration of a sixth embodiment related to configurations of DCI field format.

FIG. 18 is an illustration of a seventh embodiment related to configurations of DCI field format.

FIG. 19 is an illustration of an eighth embodiment related to configurations of DCI field format.

FIG. 20 is an illustration of an embodiment related to how a user equipment performs a method of receiving a DCI scheduling a PUSCH or PDSCH per cell on each of a plurality of cells.

FIG. 21 is an illustration of an embodiment related to how a base station performs a method of transmitting a DCI scheduling a PUSCH or PDSCH per cell on each of a plurality of cells.

### DETAILED DESCRIPTION

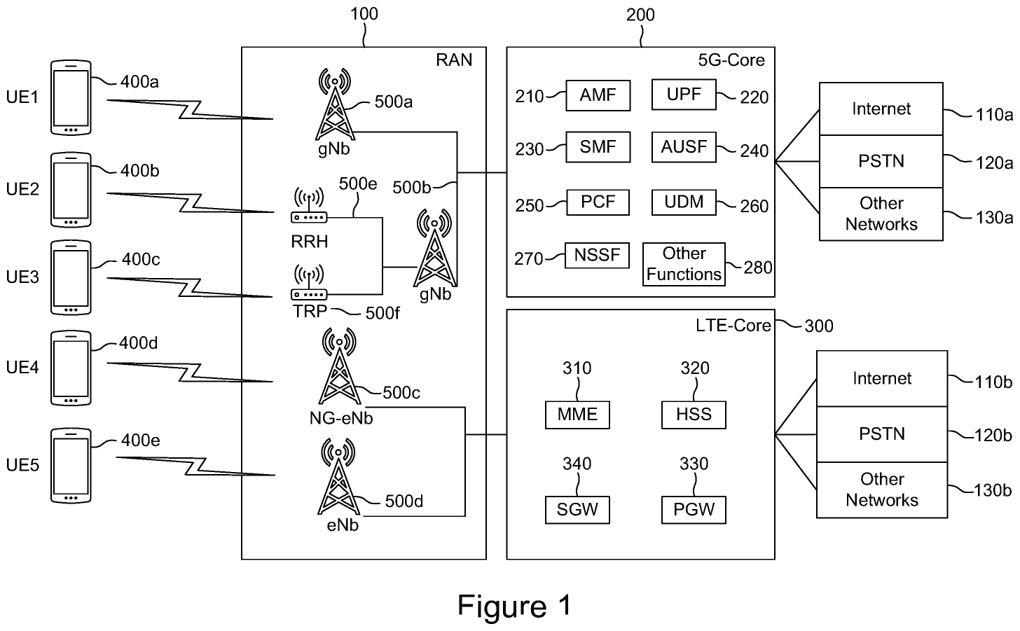

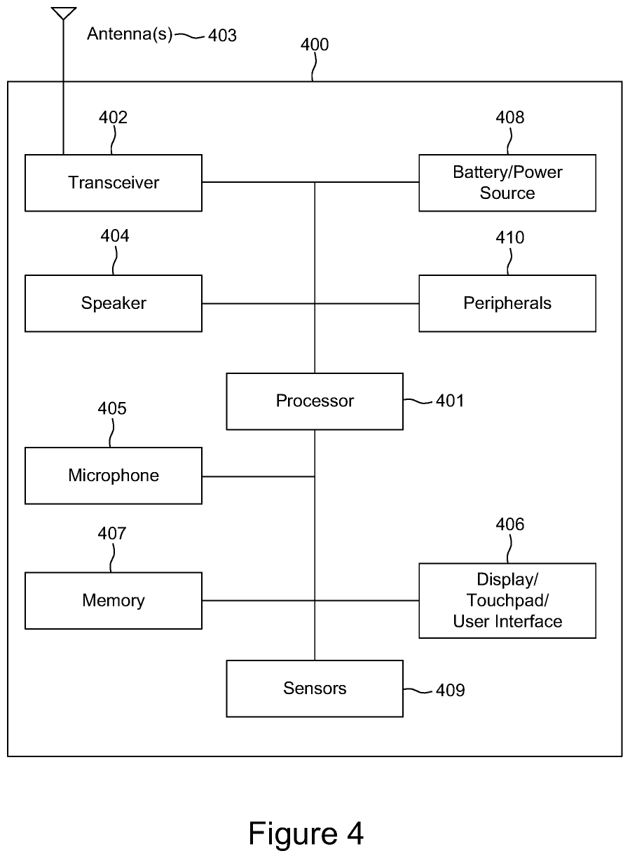

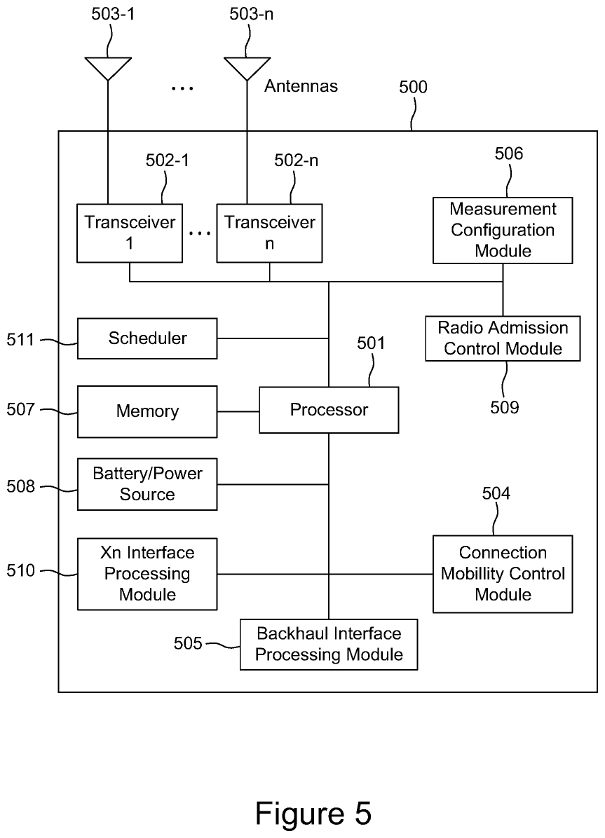

FIG. 1 is a system diagram of a wireless communication system that may be deployed to provide various communication services, such as a voice service, packet data, audio, video, and the like. The wireless communication system may include a User Equipments (UEs) (400a, 400b, 400c, 400d, 400e), RAN (100) (Radio Access Network), and a core including a 5G core (200) and/or an LTE core (300). The RAN (100) includes base stations (500a, 500b, 500c, 500d, 500e, 500f) or cells communicating with the UEs (400a, 400b, 400c, 400d, 400e). The LTE core (300) includes core network components such as MME (310), HSS (320), PGW (330), and SGW (340). The 5G core (200) includes various functions such as UPF (220), AMF (210), SMF (230), AUSF (240), NSSF (270), UDM (260), PCF (250), and other functions (280) such as NEF, NRF, AF, etc. The detailed scope and functionalities of the LTE (300) and 5G core (200) network components can be identified from the 3GPP standard specifications (including connection to internet (110a, 110b), PSTN (120a, 120b), and other networks (130a, 130b). The UEs (400a, 400b, 400c, 400d, 400e) may refer to a UE disclosed in conjunction with the description of FIG. 4 and base stations (500a, 500b, 500c, 500d, 500e, 500f) may refer to a base station disclosed in conjunction with the description of FIG. 5.

Throughout the patent specification, the user equipment may be an inclusive concept indicating a terminal utilized in wireless communication, including a UE (User Equipment) (400) in long-term evolution (LTE), 5G NR, and the like.

A base station (BS) (500) or a cell may generally refer to a station communicating with a User Equipment (UE) (400). The base station (500) may also be referred to as a Node-B, an evolved Node-B (eNb) (500c, 500d), gNodeB (gNb) (500a, 500b), MeNb, SeNb, HeNb, a Sector, a Site, transmit-receive point (TRP) (500f), a Base Transceiver System (BTS), an Access Point, a Relay Node, Integrated Access and Backhaul (IAB) node, a Remote Radio Head (RRH) (500e), a Radio Unit (RU), and the like.

In the patent specification, the base station (500) or the cell may have an inclusive concept indicating a portion of an area covered and functions performed by a Node-B, an evolved Node-B (eNb) (500d), gNodeB (gNb) (500b), MeNb, SeNb, a Sector, a Site, a Base Transceiver System (BTS), an Access Point, a Relay Node, Integrated Access and Backhaul (IAB) node, a Remote Radio Head (RRH) (500e), a Radio Unit (RU), and the like. The base station (500) or cell may include various coverage areas, such as a mega cell, a macrocell, a microcell, a picocell, a femtocell, a communication range of a relay node, an RRU, an RU, and the like.

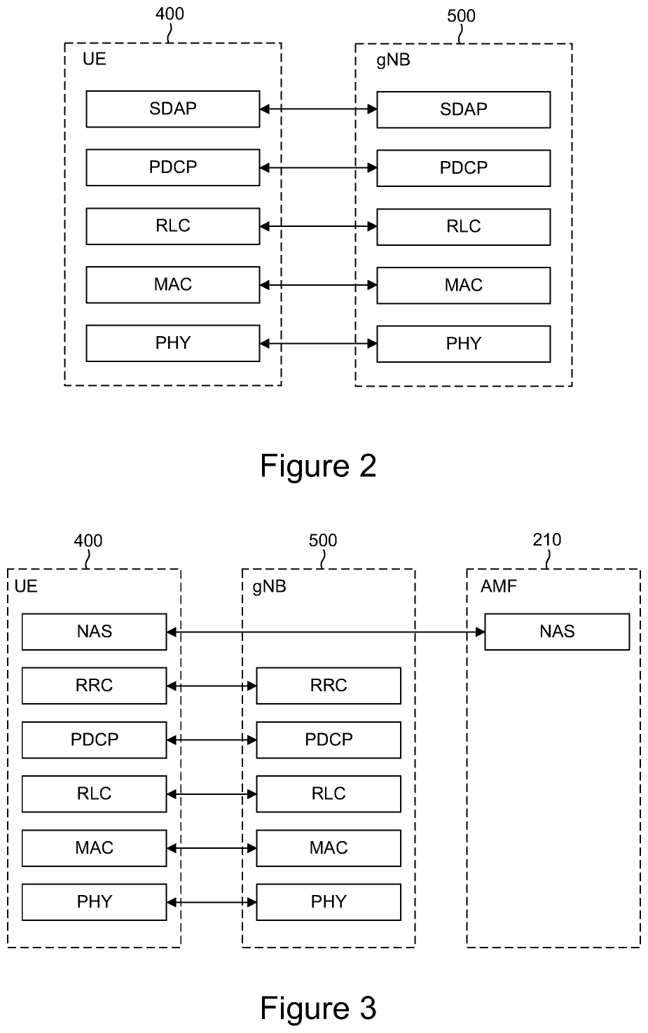

Exemplary communication between the base station (500) and UE (400) in a 5G system is disclosed in FIG. 2 for the user plane (aka data plane) protocol stack and FIG. 3 for the control plane protocol stack. A similar protocol stack also exists for UE (400) communication in an LTE system. One difference with respect to the 5G user plane protocol stack is the SDAP layer that only exists in 5G. One difference with respect to the 5G control plane protocol stack is that the NAS signalling is between UE (400) and AMF (210) whereas in LTE the NAS signalling is between UE (400) and MME (310).

As shown in FIG. 4, User Equipment (UE) (400) may include a processor (401), a transceiver (402), antenna(s) (403), a speaker (404)/microphone (405), a keypad (not shown), a display/touchpad/User interface (406), memory (non-removable memory or removable memory) (407), a power source (408) (or battery including charging circuit), sensors such as accelerometer, an e-compass, a global positioning system (GPS) chipset, NFC, and other peripherals (410) such a satellite transceiver, a digital camera (for photographs or video), a universal serial bus (USB) port, a vibration device, a hands-free headset, a Bluetooth® module, a frequency modulated (FM) radio unit, a multimedia player, a video game player module, an Internet browser, or the like. It is appreciated that the User Equipment (UE) (400) may include any sub-combination of the foregoing elements.

The processor (401) may be coupled to all or a subset of the of the following: transceiver (402), a speaker (404)/microphone (405), a keypad, a display/touchpad/User interface (406), non-removable memory, removable memory, a power source (408), sensors (409), and other peripherals (410).

As shown in FIG. 5, the Base station (500) may include a processor (501), a transceiver (502-1 . . . 502-n), antennas (503-1 . . . 503-n), memory (non-removable memory or removable memory) (507), and a power source (508) (or battery including a charging circuit). The base station (500) may be configured to host modules such as a measurement configuration module (506) for channel measurements for mobility and scheduling, radio admission control module (509) for UE (400) admission control to the network, connection mobility control (504) module for handover-related processing, backhaul Interface processing module (505) for processing messages received/transmitted to the core network, Xn interface processing module (510) for processing messages received/transmitted to other base stations, and scheduler (511) for dynamic allocation of resources to UEs in both uplink and downlink. It is appreciated that the base station (500) may include any sub-combination of the foregoing elements.

The following additional modules may also be hosted by the base station (500): Radio Resource Management for inter-cell radio resource management, radio bearer control, IP header compression, encryption and integrity protection of data, selection of an AMF (210) at UE (400) attachment when no routing to an AMF (210) can be determined from the information provided by the UE (400), routing of User Plane data towards UPF(s), routing of Control Plane information towards AMF (210), connection setup and release, scheduling and transmission of paging messages (originated from the AMF (210), scheduling and transmission of system broadcast information (originated from the AMF (210) or Operation and Maintenance), transport level packet marking in the uplink; session management; support of network slicing, QoS flow management and mapping to data radio bearers, support of UEs (400a, 400b, 400c, 400d and 400e) in RRC_INACTIVE state, distribution function for non-access stratum (NAS) messages, radio access network sharing, dual connectivity, to name a few.

The processor (401 or 501) may be a general-purpose processor, a digital signal processor (DSP), a plurality of microprocessors, a single core, or a multi-core processor, one or more microprocessors in association with a DSP core, a controller, a microcontroller, Application-Specific Integrated Circuits (ASICs), Field Programmable Gate Array (FPGAs) circuits, any other type of integrated circuit (IC), or the like. The processor (401 or 501) may perform signal coding/decoding, data processing, power control, input/output processing, or any other functionality that enables the user equipment to operate in a wireless environment. The processor (401 or 501) may be coupled to a transceiver (402 or 502-1 . . . 502-n) that may be further coupled to the antenna(s) (403 or 503-1 . . . 503-n). While the processor (401 or 501) and the transceiver (402 or 502-1 . . . 502-n) may be separate components, it is appreciated that the processor (401 or 501) and the transceiver (402 or 502-1 . . . 502-n) may be integrated in an electronic package or chip.

The antenna(s) (403 or 503-1 . . . 503-n) may include a plurality of antennas or an antenna array. The antenna(s) (403 or 503-1 . . . 503-n) is/are capable of transmitting/receiving on the entire Radio spectrum including the mmWave spectrum.

The transceiver (402 or 502-1 . . . 502-n) may be configured to modulate the signals that are to be transmitted by the antenna(s) (403 or 503-1 . . . 503-n) and to demodulate the signals that are received by the antenna(s) (403 or 503-1 . . . 503-n).

The memory (407 or 507) may include a non-removable memory or a removable memory. The non-removable memory may include a random-access memory (RAM), read-only memory (ROM), a hard disk, SSD, or any other type of memory storage device. The removable memory may include a subscriber identity module (SIM) card, a memory stick, a secure digital (SD) memory card, and the like. The memory (407 or 507) may be used for storing instructions used by the processor (401 or 501) for performing various user equipment functions including but not limited to cellular transmission and receptions. The cellular transmission and reception functions may include transmission and reception of physical channels and signals (for example, PUSCH, PUCCH, PRACH, SRS, DMRS, PDSCH, PBCH, PDCCH, PSS, SSS, DMRS, CSI-RS, and PTRS) or may include transmission and reception of higher layer data and control signaling (for example, RRC, MAC, RLC, PDCP, NAS and SDAP).

In this specification, terms such as Component Carrier (CC) or Cell may be used interchangeably. Similarly, terms such as Downlink Control Channel (PDCCH) or Downlink Control Information (DCI) may be used interchangeably.

### Carrier Aggregation (CA)

Carrier Aggregation (CA) allows two or more Component Carriers (CCs) or cells to be aggregated. As such a base station may simultaneously transmit or receive two or more CCs. Similarly, a UE may simultaneously receive or transmit on two or more CCs:
A UE with single timing advance capability for CA can simultaneously receive and/or transmit on multiple CCs corresponding to multiple serving cells sharing the same timing advance (multiple serving cells grouped in one TAG).
A UE with multiple timing advance capability for CA can simultaneously receive and/or transmit on multiple CCs corresponding to multiple serving cells with different timing advances (multiple serving cells grouped in multiple TAGs). NG-RAN ensures that each TAG contains at least one serving cell.

CA is supported for both contiguous and non-contiguous CCs. When CA is deployed, frame timing and SFN are aligned across cells that can be aggregated, or an offset in multiples of slots between the PCell/PSCell and an SCell may be configured. In 5G NR, the maximum number of configured CCs for a UE is 16 for DL and 16 for UL. In LTE up to 32 CCs might be configured for UL/DL.

A base station may configure CA based on the UE capability, UE transmission requirement, and the cell channel conditions. The base station may configure itself to perform CA. The BS may then send RRC signalling to a UE for purposes of configuring the UE for CA. A UE may be configured to perform CA by RRC signalling received from a base station.

A UE may also be configured to perform CA with two base stations in a dual-connectivity scenario.

### Cross Carrier Scheduling

In conventional Cross-carrier scheduling, the Carrier Indicator Field (CIF) allows the PDCCH of a serving cell to schedule resources on another serving cell but with the following restrictions:
When cross-carrier scheduling from an SCell to PCell is not configured, PCell can only be scheduled via its PDCCH;
When cross-carrier scheduling from an SCell to PCell is configured:
PDCCH on that SCell can schedule PCell's PDSCH and PUSCH;
PDCCH on the PCell can schedule PCell's PDSCH and PUSCH but cannot schedule PDSCH and PUSCH on any other cell;
Only one SCell can be configured to be used for cross-carrier scheduling to PCell.
When an SCell is configured with a PDCCH, that cell's PDSCH and PUSCH are always scheduled by the PDCCH on this SCell;
When an SCell is not configured with a PDCCH, that SCell's PDSCH and PUSCH are always scheduled by a PDCCH on another serving cell;
The scheduling PDCCH and the scheduled PDSCH or PUSCH can use the same or different numerologies.

The current specification enables UE to receive a single DCI from a base station and schedule PUSCH or PDSCH per cell on each of a plurality of cells. The single DCI may cross-carrier schedule a plurality of cells or self-schedule itself along with cross-carrier scheduling one or more other cell(s).

Configuring Base Station (BS) and UE with CA and Cross Carrier Scheduling

A BS may configure itself to perform CA. The BS may then send RRC signalling to a UE for purposes of configuring the UE for CA. A UE may be configured to perform CA by RRC signalling received from a base station. The RRC signalling may include parameters such as CellGroupConfig for adding additional Scells. The RRC signalling may include parameter sCellToAddModList for adding cells.

Further, a BS may configure itself to perform cross-carrier scheduling. The BS may then send RRC signalling to a UE for purposes of configuring the UE for cross-carrier scheduling. UE may be configured to perform cross-carrier scheduling by RRC signalling received from a base station. The RRC signalling may include the CrossCarrierSchedulingConfig parameter to indicate the secondary cell (Scell) is cross-carrier scheduled by which Scell or Pcell (Primary cell). The RRC signalling may also include signalling for configuring Pcell to be cross-carrier scheduled by another Scell.

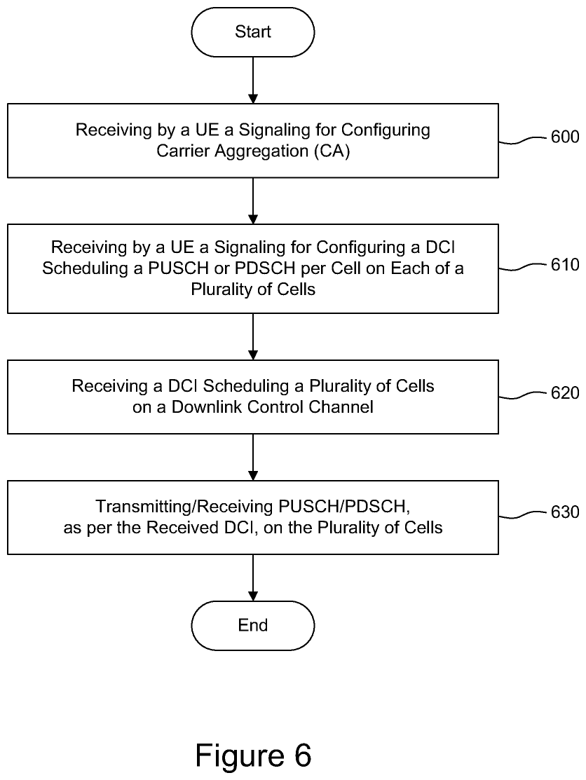

According to an embodiment, as shown in FIG. 6, a UE receives a signalling for configuring Carrier aggregation (CA) (600) from a base station and the UE configures itself for CA. The UE may also receive a signalling for configuring a DCI scheduling a PUSCH or PDSCH per cell on each of a plurality of cells (610) from a base station and the UE configures itself for DCI scheduling a PUSCH or PDSCH per cell on each of a plurality of cells. The UE may be configured for CA (600) and DCI scheduling a PUSCH or PDSCH on a plurality of cells (610), using one or more RRC messages transmitted by one or more base stations (e.g., during the initial configuration of CA or during reconfiguration of CA). Once UE is configured with CA (600) and DCI scheduling a PUSCH or PDSCH per cell on each of a plurality of cells (610), the UE may receive a PDCCH containing a DCI for scheduling the plurality of cells (620) and based on the received DCI, the UE may transmit/receive the PUSCH or PDSCH (630) on the scheduled cells.

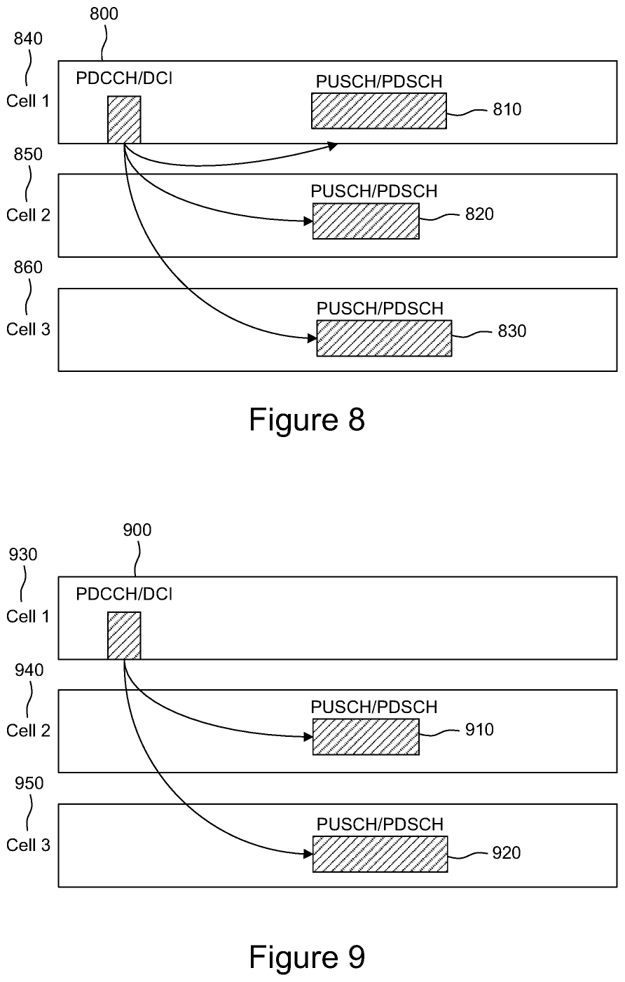

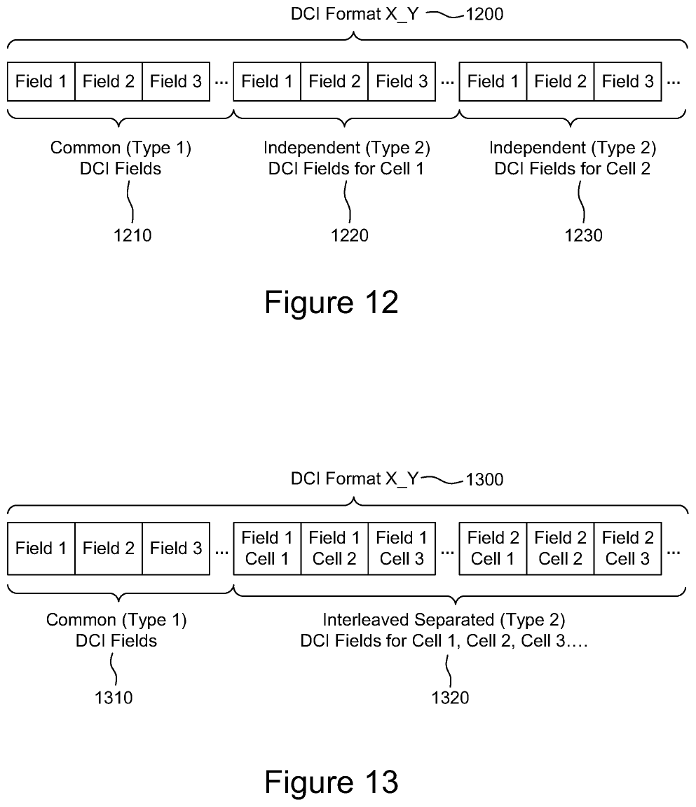

Further, in the step 620, the UE may receive the PDCCH containing the DCI (800) on a scheduling cell (840) for scheduling the plurality of cells (840, 850, 860) as shown in FIG. 8 for self-scheduling a PUSCH or PDSCH (810) and cross-carrier scheduling PUSCH or PDSCH (820, 830) on other co-scheduled cells (850, 860). Alternatively, the UE may receive the PDCCH containing the DCI (900) on a scheduling cell (930) for scheduling the plurality of cells (940, 950) as shown in FIG. 9 for cross-carrier scheduling PUSCHs or PDSCHs (910, 920) on other co-scheduled cells (940, 950). The format of DCI (800, 900) may refer to one of the DCI formats disclosed in the embodiments in conjunction with the FIGS. 12-19.

In another embodiment, the UE receives the RRC configuration message/s for configuring CA (600) and DCI scheduling PUSCH or PDSCH per cell on each of a plurality of cells (610) from a base station different from a base station transmitting the PDCCH containing the DCI for scheduling PUSCH or PDSCH per cell on each of a plurality of cells (620). The UE may transmit/receive the PUSCH or PDSCH (630) to/from the base station from which it received the DCI (S120).

In another embodiment, the UE receives the RRC configuration message/s for configuring CA (600) and DCI scheduling PUSCH or PDSCH per cell on each of a plurality of cells (610) from a same base station transmitting the PDCCH containing the DCI for scheduling a PUSCH or PDSCH on a plurality of cells (620).

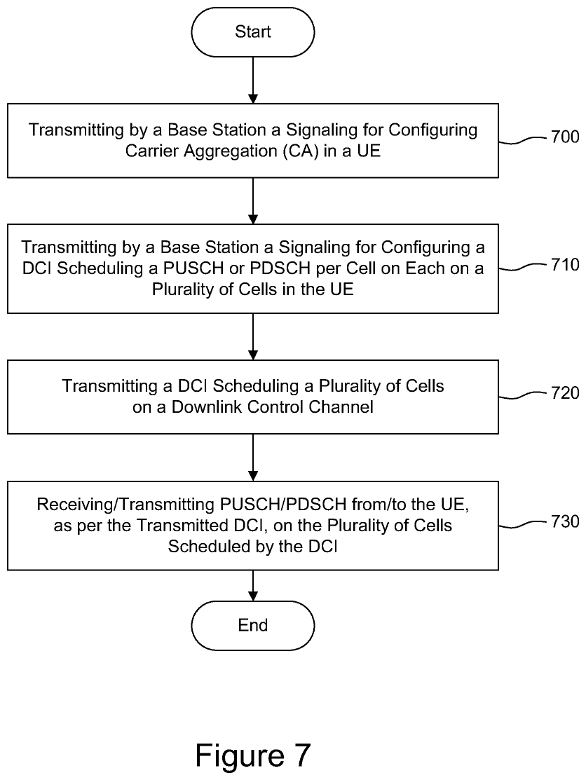

According to an embodiment, as shown in FIG. 7, a base station transmits signalling for configuring CA in a UE (700) and signalling for configuring a DCI scheduling PUSCH or PDSCH per cell on each of a plurality of cells with a single DCI in the UE (710). The base station may configure CA (700) and DCI scheduling PUSCH or PDSCH per cell on each of a plurality of cells (710), using one or more RRC messages (e.g., during the initial configuration of CA or during reconfiguration of CA). Once UE is configured with CA based on signalling received in 700 and configured with DCI scheduling PUSCH or PDSCH per cell on each of a plurality of cells based on signalling received in 710, the base station may transmit a PDCCH containing a DCI for scheduling the plurality of cells (720) and based on the transmitted DCI, the base station may receive/transmit the PUSCH/PDSCH from/to UE on the plurality of cells configured by DCI scheduling PUSCH or PDSCH per cell on each of a plurality of cells (730).

Further, in the step 720, the base station may transmit, and the UE may receive the PDCCH containing the DCI (800) on a scheduling cell (840) for scheduling the plurality of cells (840,850,860) as shown in FIG. 8 for self-scheduling a PUSCH or PDSCH (810) and cross-carrier scheduling PUSCH or PDSCH (820, 830) on other co-scheduled cells (850, 860). Alternatively, the UE may receive the PDCCH containing the DCI (900) on a scheduling cell (930) for scheduling the plurality of cells (940, 950) as shown in FIG. 9 for cross-carrier scheduling PUSCHs or PDSCHs (910, 920) on other co-scheduled cells (940, 950). The format of DCI (800, 900) may refer to one of the DCI formats disclosed in the embodiments described in conjunction with the FIGS. 12-19.

In another embodiment, the base station transmitting the RRC configuration message/s for configuring UE with CA (700) and DCI scheduling PUSCH or PDSCH per cell on each of a plurality of cells (710) is different from a base station transmitting the PDCCH containing the DCI for scheduling PUSCH or PDSCH per cell on each of a plurality of cells (720). The same base station may receive or transmit the PUSCH or PDSCH (730) from or to UE that transmitted the DCI (720).

In another embodiment, the base station transmitting the RRC configuration message/s for configuring UE with CA (700) and DCI scheduling PUSCH or PDSCH per cell on each of a plurality of cells (710) is the same base station transmitting the PDCCH containing the DCI for scheduling PUSCH or PDSCH per cell on each of a plurality of cells (720).

### UE Configurations for a Single DCI Scheduling a PUSCH Per Cell on Each of a Plurality of Cells or Scheduling a PDSCH Per Cell on Each of a Plurality of Cells.

Since NR Release-15 Dynamic spectrum sharing (DSS) between NR cell and LTE cell is supported. NR UEs are expected to outnumber LTE UEs with time. The existing DSS feature needs enhancement to address the growing number of NR UEs. A possible enhancement to reduce the load on the shared carrier is to offload the downlink control channel (PDCCH) of the shared carrier to another carrier. This can be achieved by cross-carrier scheduling a PCell from an SCell, if the Pcell is deployed in the shared carrier. Although, cross-carrier scheduling a PCell from an Scell reduces the load on the Pcell, it may add more PDCCH monitoring load on the Scell. To reduce PDCCH monitoring load on the Scell, it may be advantageous to support a single DCI on the SCell for scheduling a PUSCH or PDSCH per cell on each of a plurality of cells. By using a single DCI scheduling a PUSCH or PDSCH per cell on each of a plurality of cells, the number of monitored PDCCHs is reduced, so too is the PDCCH blocking probability.

Although problems of PCell PDCCH monitoring, while deployed in a DSS spectrum, can be solved by using a single DCI scheduling a PUSCH or PDSCH per cell on each of a plurality of cells, this solution is not limited to DSS spectrum only. Similar benefits can be achieved for cells deployed in FR1, FR2-1, FR2-2, and combinations thereof. Further, it may be beneficial to use a single DCI scheduling PUSCH or PDSCH per cell on each of a plurality of cells across RATs, for instance, LTE Cells scheduling NR Cells or vice versa.

Some of the advantages of using single DCI scheduling PUSCH or PDSCH per cell on each of a plurality of cells may include the following:
PDCCH overhead may be reduced. For example, CRC bits and common DCI bits (Type 1 DCI fields) among the scheduling and scheduled cell(s) may be saved.
PDCCH resources on the scheduled cell may be re-used for PDSCH/PUSCH transmission.
At the UE side, less PDCCH processing may be required as compared with the situation where a plurality of PDCCHs are required for scheduling a plurality of PUSCH or PDSCH.

In an embodiment, a UE may receive a signalling from a base station to configure a small bandwidth scheduling cell and ultra-wide bandwidth scheduled cells in the UE, such that UE power can be saved as a result of PDCCH monitoring occasions being reduced because of the smaller bandwidth of the scheduling cell. Additionally, the UE may receive a signalling from the base station for configuring the UE to not monitor a PDCCH for single-cell PUSCH or PDSCH scheduling when configured to monitor a PDCCH for scheduling PUSCH or PDSCH per cell on each of a plurality of cells such that UE power can be saved.

In an embodiment, a base station may be configured to transmit a signalling for configuring a UE with a small bandwidth scheduling cell and ultra-wide bandwidth scheduled cells, such that UE power can be saved as a result of PDCCH monitoring occasions being reduced because of the smaller bandwidth of the scheduling cell. Additionally, the base station may be configured to transmit a signalling to configure the UE to not monitor a PDCCH for single-cell PUSCH or PDSCH scheduling when configured for monitoring a PDCCH for scheduling PUSCH or PDSCH per cell on each of a plurality of cells such that UE power can be saved.

In another embodiment, a single DCI for scheduling a PUSCH or PDSCH per cell on each of a plurality of cells with at least one of the following UE configurations:
A DCI on a Pcell self-schedules a PUSCH or PDSCH on the PCell as well as cross-carrier schedules a PUSCH or PDSCH on other Scell(s).
A DCI on a Pcell cross-carrier schedules a PUSCH or PDSCH on Scells.
A DCI on an Scell cross-carrier schedules a PUSCH or PDSCH on a PCell as well as cross-carrier schedules PUSCH/PDSCH on other Scell(s).
A DCI on an Scell cross-carrier schedules a PUSCH or PDSCH on other SCells.
A DCI on an Scell self-schedules a PUSCH or PDSCH as well as cross-carrier schedules a PUSCH or PDSCH on a PCell and/or other PUSCH or PDSCH on Scell(s).

In another embodiment, scheduling and scheduled cells may be intra-band cells. In another embodiment, scheduling and scheduled cells may be inter-band cells. In another embodiment, scheduling and scheduled cells may include a combination of inter-band and intra-band cells.

In another embodiment, scheduling and scheduled cells may belong to the same RAT (Radio Access Technology) including, for example, LTE or NR. In another embodiment, the scheduling and scheduled cells may belong to different RATs, for example an LTE scheduling cell and NR scheduled cells, or an NR scheduling cell and LTE scheduled cells, or an LTE or NR scheduling cell and a combination of LTE and NR scheduled cells.

In another embodiment, DCI for scheduling a PUSCH or PDSCH per cell on each of a plurality of cells may be received on two or more scheduling cells to reduce PDCCH monitoring load on a single scheduling cell.

In another embodiment, a BS may configure itself to allow a group of co-scheduled cells to be scheduled only on a single scheduling cell. The BS may then send RRC signalling to a UE for purposes of configuring the UE to allow a group of co-scheduled cells to be scheduled only on a single scheduling cell. The UE may configure itself to allow a group of co-scheduled cells to be scheduled only on a single scheduling cell.

In another embodiment, a UE may be configured based on a RRC signalling received from a base station to receive a plurality of DCIs, each DCI scheduling a different group of scheduled cells, whereby each of the plurality of DCIs may be received on their respective scheduling cells, whereby the scheduling cells receiving the DCIs are different from each other.

In another embodiment, a UE may be configured based on RRC signalling received from a base station to receive a DCI scheduling either PUSCH on plurality of cells or PDSCH on plurality of cell for simplicity. No scheduling of simultaneous PUSCHs and PDSCHs is allowed among the co-scheduled cells.

In another embodiment, DCI on an unlicensed cell may schedule a PUSCH or PDSCH per cell on each of a plurality of unlicensed co-scheduled cells, or an unlicensed cell may schedule plural unlicensed and licensed co-scheduled cells, or a licensed cell may schedule plural unlicensed and/or licensed co-scheduled cells. An advantage of using DCI on an unlicensed cell for scheduling plurality of cells may be that in 5G NR multiple unlicensed bands are now available with wider bandwidths including bands 46, 96, and 60 GHz unlicensed band in the FR2-2 spectrum. In another embodiment, a UE may not be configured for unlicensed cell scheduling a set of co-scheduled licensed and/or unlicensed cells as LBT failure may affect the scheduling of plurality of cells leading to a decrease in throughput.

In another embodiment, a DCI for scheduling a PUSCH or PDSCH per cell on each of a plurality of cells is monitored by the UE in a user specific search space.

In another embodiment, a scheduling cell may schedule a plurality of cells other than the scheduling cell, where the same carrier type (FDD or TDD, licensed or unlicensed, FR1 or FR2-1 or FR2-2) is used among all the co-scheduled cells which may be the same or different to the subcarrier spacing (SCS) of the scheduling cell. The SCS of the co-scheduled cells may also be configured to be the same or different.

In another embodiment, a scheduling cell may schedule a plurality of cells other than the scheduling cell, where a different carrier type (FDD or TDD, licensed or unlicensed, FR1 or FR2-1 or FR2-2) is used among all the co-scheduled cells which may be the same or different to the SCS of the scheduling cell. The SCS of the co-scheduled cells may be configured as the same or different.

In another embodiment, a scheduling cell may schedule a plurality of cells including the scheduling cell, where the same or different carrier type (FDD or TDD, licensed or unlicensed, FR1 or FR2-1 or FR2-2) is used among all the co-scheduled cells. The SCS of the co-scheduled cells may be configured as the same or different.

### Signalling Co-Scheduled Cells

According to an embodiment a signalling mechanism is disclosed for indicating to a UE which cells are scheduled from a single DCI. A BS may configure itself with carrier aggregation (CA) and cross-carrier scheduling. The BS may then send RRC signalling to a UE for purposes of configuring the UE with carrier aggregation (CA) and cross-carrier scheduling. The UE may configure itself based on the received RRC signalling with carrier aggregation (CA) and cross-carrier scheduling.

In the conventional CA mechanism, the Carrier indicator field (CIF) in the DCI corresponds to one scheduled cell. To schedule PUSCH/PDSCH on two or more cells via a single DCI, a new indicator field indicating co-scheduled cells (CSCI field) is disclosed below in accordance with an embodiment.

In an embodiment, a bitmap may be used for the co-scheduled cells indicator (CSCI) field, where each bit represents a cell. As will be appreciated by one of ordinary skill in the art, this technique will increase the number of CSCI bits needed as the number of cells to be scheduled from a single DCI increase. For a smaller number of co-scheduled cells, however, this technique may provide a simple option for scheduling a plurality of cells. Table 1 provides an example of bitmap coding for 3 bits CSCI where each bit corresponds to a cell. In the below example LSB corresponds to cell 2, middle bit corresponds to Cell 3 and MSB corresponds to Cell 4. In this example, DCI is received on Cell 1. A person of ordinary skill in the art will appreciate that more or less bits could be used to signal more or less scheduling arrangements and that the bits therein could correspond to different cells than those shown in Table 1.

TABLE 1

| 3 bits CSCI | Definition |
|---|---|
| 000 | Self-scheduling Cell 1 |
| 001 | Cross-Scheduling Cell 2 |
| 010 | Cross-Scheduling Cell 3 |
| 011 | Cross-Scheduling Cell 2 and Cell 3 |
| 100 | Cross-Scheduling Cell 4 |
| 101 | Cross-Scheduling Cell 2 and Cell 4 |
| 110 | Cross-Scheduling Cell 3 and Cell 4 |
| 111 | Cross-Scheduling Cell 2, Cell 3, and Cell 4 |

In another embodiment, a way of scheduling multiple cells using a single DCI can includes the steps of:
receiving a downlink control information (DCI) on a cell for scheduling at least a plurality of other cells;
wherein the DCI includes a bitmap including a plurality of bit positions;
wherein each bit position of the plurality of bit positions corresponds to a respective cell among the plurality of other cells;
wherein the presence of a 1 bit in a bit position of the plurality of bit positions indicates that the respective cell among the plurality of other cells indicated by the bit position is scheduled.

A more specific embodiment of this broader concept is described in conjunction with table 1. A person of skill in the art will appreciate, however, that the number of bits represented is merely for exemplary purposes and that other numbers of bits could be used.

In another embodiment, Table 1 may be modified to include the additional self-scheduling situations for scheduling at least 2 cells as shown in table 2. A person of ordinary skill in the art will appreciate that more or less bits could be used to signal more or less scheduling arrangements and that the bits therein could correspond to different cells than those shown in Table 2.

TABLE 2

| 3 bits | |
|---|---|
| CSCI | Definition |
| 000 | Self-scheduling Cell 1 |
| 001 | Self-scheduling Cell 1 and Cross-Scheduling Cell 2 |
| 010 | Self-scheduling Cell 1 and Cross-Scheduling Cell 3 |
| 011 | Self-scheduling Cell 1 and Cross-Scheduling Cell 2 and Cell 3 |
| 100 | Self-scheduling Cell 1 and Cross-Scheduling Cell 4 |
| 101 | Self-scheduling Cell 1 and Cross-Scheduling Cell 2 and Cell 4 |
| 110 | Self-scheduling Cell 1 and Cross-Scheduling Cell 3 and Cell 4 |
| 111 | Self-scheduling Cell 1 and Cross-Scheduling Cell 2, Cell 3, |
| | and Cell 4 |

The advantage of using the above 3 bits CSCI is that it covers self-scheduling for a single cell and self-scheduling and cross-carrier scheduling for scheduling up to 3 cells.

In another embodiment, a way of scheduling multiple cells using a single DCI can includes the steps of:
receiving a downlink control information (DCI) on a cell for scheduling the cell and a plurality of other cells;
wherein the DCI includes a bitmap having a plurality of bit positions;
wherein a respective bit position of the plurality of bit positions corresponds to a respective cell among the plurality of other cells;
wherein the presence of a 1 bit in the respective bit position of the plurality of bit positions indicates that the respective cell among the plurality of other cells corresponding to the bit position, and the cell upon which the DCI is received, are scheduled.

A more specific embodiment of this broader concept is described in conjunction with table 2. A person of skill in the art will appreciate, however, that the number of bits represented is merely for exemplary purposes and that other numbers of bits could be used.

In another embodiment, table 2 can be further modified to include self-scheduling of cell 1 for all the combinations. This may facilitate scheduling up to 4 cells using a 3 bits CSCI.

Further, similar to tables 1 and 2, more tables can be created for additional CSCI bits such as 4, 5, and 6 bits to enable the scheduling of more cells.

In another bitmap embodiment, each bit indicates a self-scheduling or cross-carrier scheduling for a given cell. For scheduling 4 cells, 4 bits are assigned, where each bit indicates self-scheduling or cross-carrier scheduling. Similarly, for scheduling 3 cells a 3-bit bitmap may be used.

In another embodiment, instead of using a bitmap, an encoding may be used as shown in table 3. A person of ordinary skill in the art will appreciate that more or less bits could be used to encode more or less scheduling arrangements and that the bits therein could correspond to different cells than those shown in Table 3.

TABLE 3

| 3 bits CSCI | Definition |
|---|---|
| 000 | Self-scheduling Cell 1 |
| 001 | Cross-Scheduling Cell 2 |
| 010 | Cross-Scheduling Cell 3 |
| 100 | Cross-Scheduling Cell 4 |
| 011 | Cross-Scheduling Cell 2 and Cell 3 |
| 101 | Cross-Scheduling Cell 2 and Cell 4 |
| 110 | Cross-Scheduling Cell 3 and Cell 4 |
| 111 | Cross-Scheduling Cell 2, Cell 3, and Cell 4 |

In another embodiment, a way of scheduling multiple cells using a single DCI can includes the steps of:
receiving a downlink control information (DCI) on a cell for scheduling a plurality of other cells;
wherein the DCI includes a plurality of bits for identifying the plurality of other cells;
wherein a first non-zero sequence of bits indicates a first cell among the plurality of other cells is scheduled; and
wherein a second non-zero sequence of bits indicates a first cell among the plurality of other cells and a second cell among the plurality of other cells are scheduled.

A more specific embodiment of this broader concept is described in conjunction with table 3. A person of skill in the art will appreciate, however, that the number of bits represented is merely for exemplary purposes and that other numbers of bits could be used.

In another embodiment, table 3 can be modified to include additional self-scheduling situations for scheduling at least 2 cells as shown in table 4.

TABLE 4

| 3 bits | |
|---|---|
| CSCI | Definition |
| 000 | Self-scheduling Cell 1 |
| 001 | Self-scheduling Cell 1 and Cross-Scheduling Cell 2 |
| 010 | Self-scheduling Cell 1 and Cross-Scheduling Cell 3 |
| 011 | Self-scheduling Cell 1 and Cross-Scheduling Cell 4 |
| 100 | Self-scheduling Cell 1 and Cross-Scheduling Cell 2, and Cell 3 |
| 101 | Self-scheduling Cell 1 and Cross-Scheduling Cell 2, and Cell 4 |
| 110 | Self-scheduling Cell 1 and Cross-Scheduling Cell 3, and Cell 4 |
| 111 | Self-scheduling Cell 1 and Cross-Scheduling Cell 2, Cell 3, |
| | and Cell 4 |

In another embodiment, a way of scheduling multiple cells using a single DCI can includes the steps of:
receiving a downlink control information (DCI) on a cell for scheduling the cell and a plurality of other cells;
wherein the DCI includes a plurality of bits for identifying the plurality of other cells;
wherein a first non-zero sequence of bits indicates a first cell among the plurality of other cells, and the cell upon which the DCI is received, are self-scheduled; and,
wherein a second non-zero sequence of bits indicates a first cell among the plurality of other cells, a second cell among the plurality of other cells, and the cell upon which the DCI is received are scheduled.

A more specific embodiment of this broader concept is described in conjunction with table 4. A person of skill in the art will appreciate, however, that the number of bits represented is merely for exemplary purposes and that other numbers of bits could be used.

In another embodiment, table 3 may be modified to include a cross-carrier scheduling entry at the place of self-scheduling entry, when a UE is configured for scheduling a plurality of cells using cross-carrier scheduling only.

Table 4 may be modified to include self-scheduling cell 1 to all the combinations. This may help schedule up to 4 cells using a 3 bits CSCI.

Further, like table 3 and 4, more tables may be created for additional CSCI bits such as 4, 5, and 6 bits to enable scheduling of more cells.

In another embodiment, the CSCI field may include a 1-bit flag and a 3-bit CSCI field, where the 1-bit flag indicates whether the DCI schedules a plurality of cells or a single cell. If the 1-bit flag indicates scheduling for the plurality of cells, the 3-bit CSCI field is interpreted as the indicator of co-scheduled cells, and if the 1-bit flag indicates single-cell scheduling, the 3-bit CSCI field is interpreted as a CIF field for single-cell scheduling.

In another embodiment, an RRC signalling mechanism may be used to indicate to a UE which cells are scheduled from a single DCI. A method of creating a group of cells for simultaneous scheduling is disclosed where a group of cells is created during the (re) configuring step of cells in the UE. A predefined group of cells may be created before configuring UE for a PUSCH or PDSCH scheduling (one PDSCH or PUSCH per cell) on a plurality of cells with a single DCI. The following could be considered for purposes of creating the cell groups:
Intra-band cell grouping: the scheduling and scheduled cells belong to the same band.
Inter-band cell grouping: the scheduling cell belongs to one band and the scheduled cells belong to a different band.
Mixed cell grouping: the scheduling cell and some scheduled cells belong to the same band and other scheduled cells belong to a different band.

An advantage of using Intra-band cell grouping is that intra-band cells have more commonalities in the DCI fields and these commonalities can help in reducing overhead. An advantage of using Inter-band cell grouping is that the scheduling cell is deployed in a band where interference may be less or PDCCH blind detection probability may be higher as compared to the other scheduled cells leading to a better PUSCH or PDSCH throughput. The advantages of both intra-band cell grouping, and Inter-band cell grouping can be combined in the mixed cell grouping.

In another embodiment, a BS (for example, a BS as disclosed in conjunction with the description of FIG. 5) may configure itself with cell groups for scheduling PUSCH or PDSCH per cell on each of a plurality of cells with a single DCI. Separate cell groups may also be configured for PUSCH or PDSCH scheduling. The BS may then send RRC signalling (for example, signaling disclosed in 610 of FIG. 6 or 710 of FIG. 7) to a UE (for example, a UE as disclosed in conjunction with the description of FIG. 4) for purposes of configuring the UE for scheduling PUSCH or PDSCH per cell on each of a plurality of cells with a single DCI. The UE may configure itself based on the RRC signalling with cell groups for scheduling PUSCH or PDSCH per cell on each of a plurality of cells with a single DCI. The RRC signalling may include one or more of the following:
Cell Group ID.
Indices of the cells in the configured group
Index of the scheduling Cell

The RRC signalling may include one or more of the above parameters in a CrossCarrierSchedulingConfig or ServingCellConfig message. Also, regarding ServingCellConfig of each serving cell, an IE indicating scheduling for a plurality of cells using a single DCI may be included which configures whether the cells are scheduled by a DCI scheduling a plurality of cells.

The Cell Group ID may indicate a cell group containing a plurality of cells or a cell group containing a sub-set of the plurality of cells. The Cell Group ID is helpful in identifying a cell group when multiple cell groups are configured in the UE by the base station. When multiple cell groups are configured the RRC signaling may include multiple Cell Group IDs. The RRC signaling may also include a number of cell groups configured for scheduling PUSCH or PDSCH per cell on each of a plurality of cells with a single DCI.

Indices of the cells in the configured cell group in the RRC signaling may be arranged in an increasing order of cell indices. For example, RRC signaling containing cell indices as disclosed in conjunction with the description of table 5.

In another embodiment, the co-scheduled cells are identified from the RRC signalling configuring UE for scheduling PUSCH or PDSCH per cell on each of a plurality of cells with a single DCI.

In another embodiment, BS may associate a scheduling cell with scheduled cells in a group, and RRC signalling is provided to a UE to indicate the indices of cells in the cell group. Once a cell group is configured for scheduling PUSCH or PDSCH per cell on each of a plurality of cells with a single DCI, the subsequently received DCI on the scheduling cell for scheduling any cell in the cell group may schedules all the cells in the group. For example, receiving a DCI on a scheduling cell for self-scheduling PUSCH or PDSCH or cross-carrier scheduling PUSCH or PDSCH on any cell in the group also implicitly indicates scheduling of PUSCH or PDSCH on the other cells in the group.

In another embodiment, an RNTI may be defined for indicating a PDCCH containing a DCI for scheduling PUSCH or PDSCH per cell on each of a plurality of cells to a UE. The RNTI for indicating a PDCCH scheduling a plurality of cells is different from the RNTI(s) used for self-scheduling or cross-carrier scheduling on a single cell.

In another embodiment, for a simplified design in terms of PDCCH monitoring capabilities and RRC configuration, one cell is allowed to be part of one cell group only. The PUCCH cell group may also be configured as a cell group for scheduling PUSCH or PDSCH per cell on each of a plurality of cells with a single DCI.

In another embodiment, a CSCI field in a DCI format points to a group of scheduled cells. The group of scheduled cells acts as a virtual cell. The association of a group of scheduled cells may be pre-configured in a UE by the RRC signalling transmitted by the base station. There can be multiple groups of scheduled cells configured in a UE. The association of a group of scheduled cells may be semi-statically configured and may be reconfigured by the RRC signalling.

In another embodiment, scheduled cells follow a predefined combination configured to UE by RRC signalling. For example, a cell corresponding to Cell index=001 and cells corresponding to cell indices 010, 011, etc. may be bundled together. In this case, a CSCI field indicates one cell yet may schedule plural cells. The cell bundling configuration may be semi-static and may be updated as per requirement.

In another embodiment, scheduled cells may be configured to be scheduled by a DCI scheduling a plurality of cells in only one scheduling cell.

In another embodiment, to limit DCI size, a maximum number of scheduled cells configured for scheduling PUSCH or PDSCH per cell on each of a plurality of cells in a UE by RRC configuration is selected from a set of {2,3,4}. Depending on the selected configuration of maximum number of cells, various combinations of co-scheduled cells may be formed (for example, as shown in table 5) for co-scheduling PUSCH or PDSCH on a plurality of cells.

In another embodiment, a way of scheduling multiple cells using a single DCI can includes the steps of:
receiving an RRC message including information correlating a first value to a first plurality of cells and correlating a second value to a second plurality of cells; and
receiving a downlink control information (DCI), after receiving the RRC message, the DCI includes the first value or the second value for scheduling the plurality of cells indicated by the first value or the second value.

A more specific embodiment of this broader concept is described in conjunction with table 5. A person of skill in the art will appreciate, however, that the number of bits represented is merely for exemplary purposes and that other numbers of bits could be used.

In another embodiment, BS (for example, a BS as disclosed in conjunction with the description of FIG. 5) may configure a set of co-scheduled cell indicator (CSCI) values and associate each CSCI value with one or more cells as presented in an exemplary table 5. Then, the BS provides RRC signalling (for example, signaling disclosed in 710 of FIG. 7) for configuring a UE (for example, a UE as disclosed in conjunction with the description of FIG. 4) with the set of CSCI values and the associated cell or cells. As shown in table 5, cell values in each row may be arranged as per the ascending order of cell indices. Further, as shown in table 5, RRC signaling includes configuration for each row of the table including a CSCI value and corresponding combinations of co-scheduled cells. The RRC signaling may also include a number of rows, for example, in table 5, 8 rows are indicated. The UE may configure itself based on the received RRC signalling (for example, signaling disclosed in 610 of FIG. 6) with the set of co-scheduled cell indicator (CSCI) values and store the received set of CSCI values and the associated cell combinations, where each CSCI value in the set corresponds to a combination of the cells. Table 5 below shows one such example for CSCI values for 3 bits (0-7). A person of ordinary skill in the art will appreciate that more or less bits could be used to signal more or less scheduling arrangements and that the bits therein could correspond to different cells than those shown in Table 5.

TABLE 5

| CSCI | Scheduled cells |
|---|---|
| 0 | Cell 1, Cell 2 |
| 1 | Cell 1, Cell 3, Cell 4 |
| 2 | Cell 2, Cell 3 |
| . . . | . . . |
| 7 | Cell 1, Cell 2, Cell 3, Cell 4 |

The DCI scheduling UE for PUSCH or PDSCH per cell on each of a plurality of cells (620, 720) may contain a CSCI value in the DCI for indicating a combination of cells from the set of combinations of cells configured by RRC. The UE may extract the CSCI value and identify the cells for which the received DCI is applicable by comparing it with the stored CSCI values and cell combinations received from the BS and accordingly transmit/receive PUSCH or PDSCH on each of the identified cells (630, 730). The DCI format for scheduling a UE for PUSCH or PDSCH per cell on each of a plurality of cells may refer to any one of a DCI format disclosed in the embodiments described in conjunction with the FIGS. 12-19.

### Enhancements to DCI Format for Scheduling PUSCH or PDSCH Per Cell on Each of a Plurality of Cells

For scheduling PUSCH or PDSCH per cell on each of a plurality of cells with a single DCI, a different DCI format may be used for scheduling. The DCI format design may consider scheduling trade-off between DCI scheduling efficiency and scheduling flexibility:
For intra-band CA, the focus may be more on DCI scheduling efficiency because intra-band carriers can have the same channel properties.
For inter-band CA, the focus may be more on scheduling flexibility because inter-band carriers may require different physical-layer configurations for better data transmission efficiency due to different channel properties.

If the scheduled cells are in different bands and have different bandwidths/numerologies, more DCI fields may need to be independent, while if they are in the same band, more DCI fields may be joint/common.

In an embodiment, the size of a DCI for scheduling PUSCH or PDSCH per cell on each of a plurality of cells is selected as the minimum DCI size according to different configurations of the scheduled cells. Many DCI fields may be present only once, for example, HARQ-ACK-related fields for PDSCH scheduling such as DAI, K1, and PUCCH resources may be signalled only once.

In another embodiment, a predefined relationship can be established between the DCI fields of scheduled cells. For example, one of the scheduled cells can be considered as the primary scheduled cell and the DCI fields of the other scheduled cell(s) may be interpreted from the DCI fields of the primary scheduled cell.

In another embodiment, the primary scheduled cell is the one with the largest DCI format size.

In another embodiment, the interpretation of the DCI fields for other scheduled cell(s) may be done according to the BWP switching rules, for example, the UE may
for each information field in the DCI format
   if the size of the information field is smaller than the one required for the DCI format interpretation for the UL BWP or DL BWP that is indicated by the bandwidth part indicator, the UE prepends zeros to the information field until its size is the one required for the interpretation of the information field for the UL BWP or DL BWP prior to interpreting the DCI format information fields, respectively
   if the size of the information field is larger than the one required for the DCI format interpretation for the UL BWP or DL BWP that is indicated by the bandwidth part indicator, the UE uses a number of least significant bits of the DCI format equal to the one required for the UL BWP or DL BWP indicated by bandwidth part indicator prior to interpreting the DCI format information fields, respectively
set the active UL BWP or DL BWP to the UL BWP or DL BWP indicated by the bandwidth part indicator in the DCI format

If a bandwidth part indicator field is configured in a DCI format for PUSCH and indicates an active UL BWP with different SCS configuration μ, or with different number

$${N}_{RB - set , UL}^{BWP}$$

of RB sets, than a current active UL UL BWP, the UE may determine an uplink frequency domain resource allocation Type 2 based on X′ bits and Y′ bits that are generated by independently truncating or padding the X MSBs and the Y LSBs [6, TS 38.214, release 17] of the frequency domain resource assignment field of DCI format 0_1, where truncation starts from the MSBs of the X bits or the Y bits, zero-padding prepends zeros to the X bits or the Y bits, and
if the indicated active UL BWP has SCS configuration μ=1 and the current active BWP has SCS configuration μ=0, the X MSBs may be truncated to X′=X-1 bits, or
if the indicated active UL BWP has SCS configuration μ=0 and the current active BWP has SCS configuration μ=1, the X MSBs may be zero-padded to X′=X+1 bits
otherwise, the X MSBs may remain unchanged and
the Y LSBs may be truncated or zero-padded to

$${Y}^{′} = ⌈ {log}_{2} ( \frac{{N}_{RB - set , UL}^{BWP} ( {N}_{RB - Ret , UL}^{BWP} + 1 )}{2} ) ⌉$$

bits where

$${N}_{RB - set , UL}^{BWP}$$

is a number of RB sets configured for teh indicated active UL BWP

A UE may not expect to detect a DCI format with a BWP indicator field that indicates an active DL BWP or an active UL BWP change with the corresponding time domain resource assignment field providing a slot offset value for a PDSCH reception or PUSCH transmission that is smaller than a delay required by the UE for an active DL BWP change or UL BWP change, respectively.

### Single Transport Block (TB) Per Cell

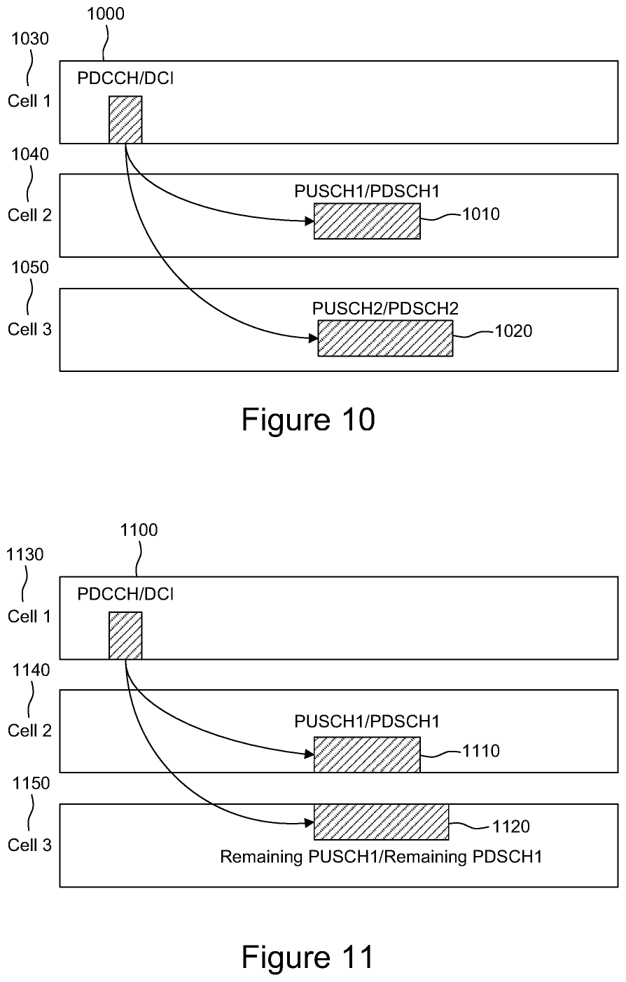

FIG. 10 presents scheduling PUSCH or PDSCH per cell using a scheduling cell (1030) on each of a plurality of cells (1040, 1050) with a single DCI (1000) in accordance with an embodiment, where plural PUSCH or PDSCH may carry different transport blocks (TBs) (1010 and 1020).

The DCI payload may be reduced by exploiting the redundancy and semi-static configuration of the various transmission/reception parameters:

The Fields of the DCI May be Divided into Three Types:
Type 1 field: common for each of the co-scheduled cells for the scheduled PUSCH/PDSCH
Type 2 field: independent for each of the co-scheduled cells for the scheduled PUSCH/PDSCH
Type 3 field: flexible either common or independent among the co-scheduled cells for the scheduled PUSCH/PDSCH depending on network configuration.

The DCI payload size may be reduced significantly by exploiting the redundancies provided by Type 1 DCI fields. The Type 3 DCI field(s) may be semi-statically (re) configured as Type 1 or Type 2 DCI fields. The base station may semi-statically (re) configure the Type 3 field(s) and share the information of such field(s) to UE via RRC signalling. The network operator may also pre-configure the Type 3 DCI fields as Type 1 or Type 2 DCI fields as per the network requirement. An example of Type 3 fields includes the following: in case of collocated deployments, co-scheduled cells may share beam related DCI fields such as transmission configuration indication (TCI), SRS resource indicator (SRI), antenna port indication, etc., and these DCI fields may be configured as Type 1, while for non-collocated deployments beam related DCI fields may be configured as Type 2.

### Exemplary Type 1 and Type 2 DCI Fields of a DCI Format for Scheduling PDSCH on a Plurality of Cells:

Type 1 DCI fields: CSCI field, Identifier for DCI formats, Downlink assignment index, TPC for scheduled PUCCH, PUCCH resource indicator, PDSCH-to-HARQ timing indicator.
Type 2 DCI fields: New data indicator, Redundancy version, Modulation and coding scheme, Frequency domain resource assignment, Time domain resource assignment, Bandwidth part indicator, HARQ process number.
Type 3 DCI fields: Antenna port(s), transmission configuration indication (TCI), SRS request, DMRS sequence initialization.

One or more of the following additional DCI fields may be configured in a DCI format scheduling PDSCH on a plurality of cells either as Type 1 or Type 2 DCI field: PRB bundling size indicator, Rate matching indicator, ZP CSI-RS trigger, VRB-to-PRB mapping, One-shot HARQ-ACK request, ChannelAccess-Cpext, etc.

### Exemplary Type 1 and Type 2 DCI Fields of a DCI Format for Scheduling PUSCH on a Plurality of Cells:

Type 1 DCI fields: CSCI field, Identifier for DCI formats, Downlink assignment index.
Type 2 DCI fields: New data indicator, Redundancy version, Modulation and coding scheme, Frequency domain resource assignment, Time domain resource assignment, Bandwidth part indicator, HARQ process number.
Type 3 DCI fields: Antenna port(s), SRS request, SRS resource indicator (SRI), DMRS sequence initialization.

One or more of the following additional DCI fields may be configured in a DCI format scheduling PDSCH on a plurality of cells either as Type 1 or Type 2 DCI field: TPC command for scheduled PUSCHs, ChannelAccess-Cpext, CSI request, beta offset indicator, etc.

In an embodiment, one or more of DCI field(s) in tables 6 and 7 may be semi-statically (re) configured as Type 1 fields by RRC signalling. For example, Frequency domain resource assignment (FDRA) and/or Time-domain resource assignment (TDRA) may be semi-statically (re) configured as Type 1 DCI fields for the co-scheduled cells. Hence, a single field in the DCI can indicate the FDRA or TDRA for all the co-scheduled cells.

For simplicity, it may be beneficial to have a common start time for the scheduled PUSCH or PDSCH across cells, as a DCI field can indicate the time domain resources for the co-scheduled cells. The configuration of a common start time for scheduled PUSCH or PDSCH may be indicated to the UE by RRC signalling or physical layer signalling. Alternatively, a predefined time offset may be configured for PUSCH/PDSCH transmission/reception start time across the cells, with this configuration also the UE may transmit/receive PUSCH or PDSCH across cells using a DCI field. The predefined time offset value may be provided to UE by either RRC signalling or physical layer signalling.

The DCI fields in table 6 are a list of fields in the DCI formats that may be used for scheduling PDSCH.

TABLE 6
DCI field types for PDSCH
DCI field

Identifier for DCI formats
CSCI
Bandwidth part indicator
PRB bundling size indicator
Rate matching indicator
ZP CSI-RS trigger
Frequency domain resource assignment
Time domain resource assignment
Modulation and coding scheme TB1
New data indicator TB1
Redundancy version TB1
Modulation and coding scheme TB2
New data indicator TB2
Redundancy version TB2
HARQ process number
VRB-to-PRB mapping
Downlink assignment index
TPC command for scheduled PUCCH
PUCCH resource indicator
PDSCH-to-HARQ feedback timing indicator
Antenna port(s)
SRS request
DMRS sequence initialization
Transmission configuration indication
CBG transmission information (CBGTI)
CBG flushing out information (CBGFI)
One-shot HARQ-ACK request
PDSCH group index
New feedback indicator
Number of requested PDSCH group(s)
ChannelAccess-CPext
Priority indicator
Minimum applicable scheduling offset indicator
SCell dormancy indication
CRC

The DCI fields in table 7 are a list of DCI fields that may be used for scheduling PUSCH.

TABLE 7
DCI field types for PUSCH
DCI field

Identifier for DCI formats
CSCI
DFI flag
Bandwidth part indicator
Frequency domain resource assignment
Time domain resource assignment
Frequency hopping flag
Modulation and coding scheme TB1
New data indicator TB1
Redundancy version TB1
Modulation and coding scheme TB2
New data indicator TB2
Redundancy version TB2
HARQ process number
TPC command for scheduled PUSCH
Second TPC command for scheduled PUSCH
ChannelAccess-CPext
ChannelAccess-CPext-CAPC
Open-loop power control parameter set indication
Priority indicator
Invalid symbol pattern indicator
Minimum applicable scheduling offset indicator
SCell dormancy indication
Sidelink assignment index*
PDCCH monitoring adaptation indication
UL/SUL indicator**
HARQ-ACK bitmap
1st downlink assignment index
2nd downlink assignment index
SRS resource set indicator
Second SRS resource indicator
SRS resource indicator
Precoding information and number of layers
Second Precoding information
Antenna ports
SRS request
SRS offset indicator
CSI request
CBG transmission information (CBGTI)
PTRS-DMRS association
Second PTRS-DMRS association
beta_offset indicator
DMRS sequence initialization
UL-SCH indicator
CRC

* “Sidelink assignment index” field may not be applicable for a DCI format for scheduling a plurality of cells.
** In a cell group at most one SUL is configured, therefore, a DCI format for scheduling a plurality of cells may not need

a “UL/SUL indicator” field in the DCI. If required, the “UL/SUL indicator” may be dynamically determined by the RRC configuration.

In an embodiment, Release-16 NR-U/URLLC/Power saving related DCI fields may not be included in a DCI format for scheduling a plurality of cells. Examples of such DCI fields for PDSCH scheduling are One-shot HARQ-ACK request, PDSCH group index, New feedback indicator, Number of requested PDSCH group(s), ChannelAccess-Cpext, Priority indicator, Minimum applicable scheduling offset indicator and SCell dormancy indication. Similarly, examples of such DCI fields for PUSCH scheduling are ChannelAccess-Cpext, ChannelAccess-CPext-CAPC, Priority indicator, Invalid symbol pattern indicator, Minimum applicable scheduling offset indicator, SCell dormancy indication, Open-loop power control parameter set indication, and DFI Flag.

In another embodiment, a Cell Bit Size Field indicating bits allocated to each cell in the DCI may be included in a DCI format for scheduling PUSCH or PDSCH per cell on each of a plurality of cells. For example, a single DCI in 5G supports 140 bits (excluding CRC), the 140 bits may include the Type 1 fields and Type 2 fields. Since the bits for Type 1 fields may be fixed and common for all the scheduled cells, hence, only Type 2 fields would vary among the scheduled cells. The Cell Bit Size Field may indicate which cells are scheduled with a predefined number of bits in Type 2 fields. The predefined number of bits in Type 2 fields may be configured as a cumulative number of bits in Type 2 fields that are present for each scheduled cell. In an alternative embodiment, the Cell Bit Size Field may indicate a predefined combination of bits per cell as shown in table 8. The information of predefined combinations may be provided to UE by RRC signalling during the configuration of scheduling PUSCH or PDSCH per cell on each of a plurality of cells. Table 8 is provided with an example of 2 bits, but it may not be restricted to 2 bits only, it may be extended as per the need and number of co-scheduled cells.

TABLE 8

| Cell Bit Size Field | Cell 1 | Cell 2 | Cell 3 |
|---|---|---|---|
| 00 | X1 bits | X2 Bits | X2 Bits |
| 01 | X1 bits | X2 Bits | X1 Bits |
| 10 | X2 bits | X1 Bits | X2 Bits |
| 11 | X1 bits | X1 Bits | X1 Bits |

### In Another Embodiment, a Way of Scheduling Multiple Cells Using a Single DCI can Includes the Steps of:

receiving a downlink control information (DCI) for scheduling a plurality of cells, wherein the DCI includes at least one common field applicable to the plurality of cells;
wherein the DCI includes at least one independent field applicable to a first cell of the plurality of cells;
and wherein the DCI includes at least one independent field applicable to a second cell of the plurality of cells.

A more specific embodiment of this broader concept is described in conjunction with FIG. 12. A person of skill in the art will appreciate, however, that the number of cells and fields represented is merely for exemplary purposes and that other numbers of cells/fields could be used.

In another embodiment, a DCI format X_Y (It may be referred to as DCI Format X_Y where X=0 is for PUSCH scheduling, and X=1 is for PDSCH scheduling, and Y indicates the format number that may have values 3, 0a, 1a, 2a, or the like) (1200) for scheduling PUSCH/PDSCH on the plural cells is disclosed in FIG. 12. As shown therein Type 1 DCI fields may be grouped together (1210), and Type 2 DCI fields may be grouped cell-wise starting from cell 1 (1220), cell 2 (1230), and so on. The Type 2 DCI fields (1220 and 1230) may be grouped according to cell indices (starting from a smallest or a largest cell index) or according to the Type 2 DCI fields payload sizes of the cells. A person of skill in the art will appreciate that the Type 1 or Type 2 DCI fields for PUSCH or PDSCH scheduling may include DCI fields categorized as Type 1 or Type 2 in other embodiments of the present disclosure. Further, Type 1 DCI field may include a CSCI field which may be configured as per the concepts described in conjunction with the description of the tables 1-5. The Type 2 DCI fields may be ordered in the same order of cell indices as indicated by a CSCI field in the DCI, the order of cell indices indicated by the CSCI field is described in conjunction with description of the tables 1-5.

An advantage of using the DCI format, as disclosed in FIG. 12, is that the processing of cell 1 is completed before cell 2, and UE may start preparing for earlier transmission/reception for cell 1 as compared to cell 2 reducing the wait time for cell 1.

### In Another Embodiment, a Way of Scheduling Multiple Cells Using a Single DCI can Includes the Steps of:

receiving a downlink control information (DCI) for scheduling a plurality of cells;
wherein the DCI includes at least one common field applicable to the plurality of cells;
wherein the DCI includes a first independent field applicable to a first cell of the plurality of cells and a second independent field applicable to the first cell of the plurality of cells;
wherein the DCI includes a first independent field applicable to a second cell of the plurality of cells and a second independent field applicable to the second cell of the plurality of cells;
wherein the first independent field applicable to a first cell of the plurality of cells and the first independent field applicable to a second cell of the plurality of cells precede, in the DCI, the second independent field applicable to a first cell of the plurality of cells and the second independent field applicable to a second cell of the plurality of cells.

A more specific embodiment of this broader concept is described in conjunction with FIG. 13. A person of skill in the art will appreciate, however, that the number of cells and fields represented is merely for exemplary purposes and that other numbers of cells/fields could be used.

In another embodiment, a DCI format X_Y (It may be referred to as DCI Format X_Y where X=0 is for PUSCH scheduling, and X=1 is for PDSCH scheduling, and Y indicates the format number that may have values 3, 0a, 1a, 2a, or the like) (1300) for scheduling PUSCH/PDSCH on the plural cells is disclosed in FIG. 13. As shown therein Type 1 DCI fields (1310) may be grouped together, and Type 2 DCI fields may be cell interleaved (1320), where field 1 may be grouped for all the co-scheduled cells followed by field 2 for all the co-scheduled cells, and so on. The interleaved Type 2 DCI fields may have a predefined order, for example, field 1 of cell index 1 is followed by field 1 of cell index 2, and so on. The predefined order may be based on cell indices, or the order may be pre-configured by RRC signalling while configuring the co-scheduled cell group. The cell index-based ordering may be done such that the combinations of cells with the smallest (or biggest) cell index may come first as compared to the others cell indices. For example, for the co-scheduled cell indices of 1, 3, and 4, Type 2 field 1 of cell index 1 is followed by Type 2 field 1 of cell index 3 which is followed by Type 2 field 1 of cell index 4. A person of skill in the art will appreciate that the Type 1 or Type 2 DCI fields for PUSCH or PDSCH scheduling may include DCI fields categorized as Type 1 or Type 2 in other embodiments of the present disclosure. Further, Type 1 DCI field may include a CSCI field which may be configured as per the concepts described in conjunction with the description of the tables 1-5. The Type 2 DCI fields may be ordered in the same order of cell indices as indicated by a CSCI field in the DCI, the order of cell indices indicated by the CSCI field is described in conjunction with description of the tables 1-5.

### In Another Embodiment, a Way of Scheduling Multiple Cells Using a Single DCI can Includes the Steps of:

receiving a downlink control information (DCI) for scheduling a plurality of cells;
wherein the DCI includes at least one common field applicable to a first cell of the plurality of cells and a second cell of the plurality of cells;
wherein the DCI includes at least one common field applicable to a third cell of the plurality of cells and a fourth cell of the plurality of cells.

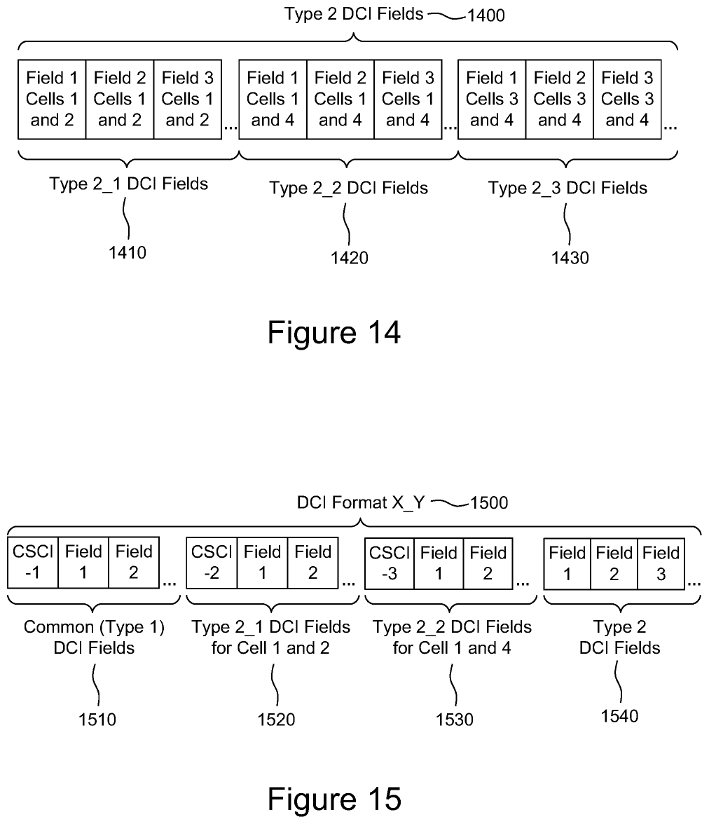

A more specific embodiment of this broader concept is described in conjunction with FIG. 14. A person of skill in the art will appreciate, however, that the number of cells and fields represented is merely for exemplary purposes and that other numbers of cells/fields could be used.

In another embodiment, Type 2 DCI fields (1400) may further have commonalities among the sub-set of the cells as shown in FIG. 14. For example, in a group of 4 co-scheduled cells in addition to Type 1 fields (for example, 1210 or 1310 as show in in FIGS. 12 and 13) some of the Type 2 DCI fields may have commonalities among the subset of 2 or 3 cells. The common Type 2 field combination for Cells 1 and 2 may be called Type 2_1 (1410), similarly cells 1 and 4 may be called Type 2_2 (1420), cells 3 and 4 may be called Type 2_3 (1430), and so on. These additional commonalities among the sub-set of the cells may be due to collocation of cells, due to intra-band CA, due to similar interference characteristics, etc. Therefore, it may be beneficial to exploit additional redundancy in the Type 2 DCI fields. A person of skill in the art will appreciate that the Type 2 DCI fields for PUSCH or PDSCH scheduling may include DCI fields categorized as Type 2 in other embodiments of the present disclosure.

### In Another Embodiment, a Way of Scheduling Multiple Cells Using a Single DCI can Includes the Steps of:

receiving a downlink control information (DCI) comprising
   a first co-scheduled cell indicator (CSCI) indicating a first plurality of cells; wherein the first CSCI associated with a first common field;
   a second CSCI indicating a second plurality of cells from amongst the first plurality of cells; wherein the second CSCI associated with a second common field.

A more specific embodiment of this broader concept is described in conjunction with FIG. 8. A person of skill in the art will appreciate, however, that the number of cells and fields represented is merely for exemplary purposes and that other numbers of cells/fields could be used.

As shown in FIG. 15, DCI format X_Y (1500) may have plural co-scheduled cell indicator fields (CSCIs) to indicate the various combinations of co-scheduled cells for the DCI fields in accordance with an embodiment. For example, CSCI-1 may be used to indicate the group of co-scheduled cells and it is part of the Type-1 DCI fields (1510), while CSCI-2 may be used to indicate a subset of co-scheduled cells among the group of co-scheduled cells for Type 2_1 DCI fields (1520), similarly, CSCI-3 may be used to indicate a subset of co-scheduled cells among the group of co-scheduled cells for Type 2_2 DCI fields (1530) and so on. The Type 2 DCI fields (1540) which have no commonality among the co-scheduled cells may also be indicated in a similar manner as shown in FIGS. 12 and 13. A predefined order may be used for ordering Type 2_1 (1520), Type 2_2 (1530), Type 2_3 (1540), etc. DCI fields. The order may be based on cell index, or the order may be pre-configured by RRC signalling while configuring the co-scheduled cell group. The cell index-based ordering may be done such that the combinations of cells with the smallest (or biggest) cell index may come first as compared to the others. Taking an example of DCI format X_Y (1400) as shown in FIG. 14 in accordance with an embodiment, Type 2_1 DCI fields (1410) indicating commonality for Cell index 1 and 2 may come first as compared to Type 2_2 DCI fields (1420) indicating commonality for Cell index 1 and 4, similarly, Type 2_3 DCI fields (1430) indicating commonality for Cell index 3 and 4 may come after the Type 2_2 DCI fields (1420) indicating commonality for Cell index 1 and 4. A person of skill in the art will appreciate that the Type 1 or Type 2 DCI fields for PUSCH or PDSCH scheduling may include DCI fields categorized as Type 1 or Type 2 in other embodiments of the present disclosure. Further, Type 1 DCI field may include a CSCI field which may be configured as per the concepts described in conjunction with the description of the tables 1-5.

In another embodiment, a BS (for example, a BS described in conjunction with the description of FIG. 5) may provide a signalling (for example, signaling described in 710) to configure a UE (for example, a UE described in conjunction with the description of FIG. 4), the UE may configure itself, based on the received signalling (for example, a signaling described in 610), with a primary cell group of co-scheduled cells, and the UE may be further configured with one or more secondary cell groups, each containing a sub-set of cells in the primary cell group. The primary cell group may have one or more DCI fields common to all the co-scheduled cells and the secondary cell group may have one or more DCI fields (other than the common DCI fields of the primary cell group) common to the sub-set of cells in the secondary cell group. The UE configuration of primary and secondary cell groups may be performed semi-statically via RRC configuration information. The RRC configuration information may include at least one of cell Indices of scheduled cells, a cell index of the scheduling cell, a primary cell group ID, or a secondary cell group ID.

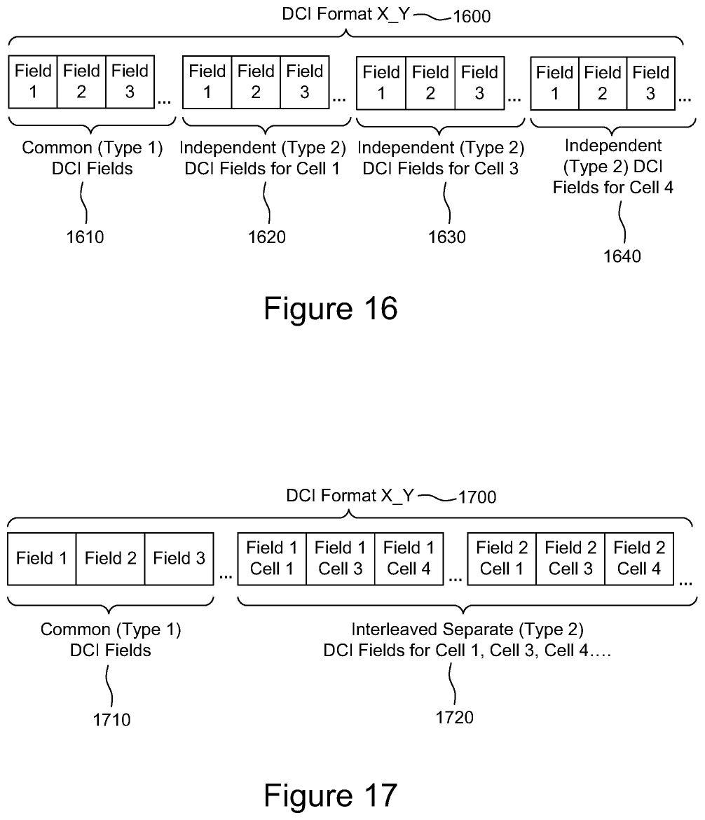

In another embodiment, a DCI format X_Y (It may be referred to as DCI Format X_Y where X=0 is for PUSCH scheduling, and X=1 is for PDSCH scheduling, and Y indicates the format number that may have values 3, 0a, 1a, 2a, or the like) (1600) for scheduling PUSCH/PDSCH on the plural cells is disclosed in FIG. 16. As shown therein Type 1 DCI fields may be grouped together (1610), and Type 2 DCI fields may be grouped according to the cell indices. For example, Type 2 DCI fields of cell index 1 (1620) are followed by Type 2 DCI fields cell index 3 (1630), followed by Type 2 DCI fields cell index 4 (1640) and so on. The grouping of Type 2 DCI fields (1620, 1630 and 1640) may start from a smallest or a largest cell index. The cell indices of the co-scheduled cells may be contiguous or non-contiguous. A person of skill in the art will appreciate that the Type 1 or Type 2 DCI fields for PUSCH or PDSCH scheduling may include DCI fields categorized as Type 1 or Type 2 in other embodiments of the present disclosure. Further, Type 1 DCI field may include a CSCI field which may be configured as per the concepts described in conjunction with the description of the tables 1-5. The Type 2 DCI fields may be ordered in the same order of cell indices as indicated by a CSCI field in the DCI, the order of cell indices indicated by the CSCI field is described in conjunction with description of the tables 1-5.

In another embodiment, a DCI format X_Y (It may be referred to as DCI Format X_Y where X=0 is for PUSCH scheduling, and X=1 is for PDSCH scheduling, and Y indicates the format number that may have values 3, 0a, 1a, 2a, or the like) (1700) for scheduling PUSCH/PDSCH on the plural cells is disclosed in FIG. 17. As shown therein Type 1 DCI fields (1710) may be grouped together, and Type 2 DCI fields may be cell interleaved (1720), where field 1 may be grouped for all the co-scheduled cells followed by field 2 for all the co-scheduled cells, and so on. The interleaved Type 2 DCI fields may have a predefined order, for example, field 1 of cell index 1 is followed by field 1 of cell index 3, which is followed by field 1 of cell index 4, and so on, in an ascending order of cell indices. The cell index-based ordering may be done such that the combinations of cells with the smallest cell index may come first as compared to the others cell indices. The cell indices of the co-scheduled cells may be contiguous or non-contiguous. For example, as shown in FIG. 17, for the co-scheduled cell indices of 1, 3, and 4, Type 2 field 1 of cell index 1 is followed by Type 2 field 1 of cell index 3 which is followed by Type 2 field 1 of cell index 4. A person of skill in the art will appreciate that the Type 1 or Type 2 DCI fields for PUSCH or PDSCH scheduling may include DCI fields categorized as Type 1 or Type 2 in other embodiments of the present disclosure. Further, Type 1 DCI field may include a CSCI field which may be configured as per the concepts described in conjunction with the description of the tables 1-5. The Type 2 DCI fields may be ordered in the same order of cell indices as indicated by a CSCI field in the DCI, the order of cell indices indicated by the CSCI field is described in conjunction with description of the tables 1-5.

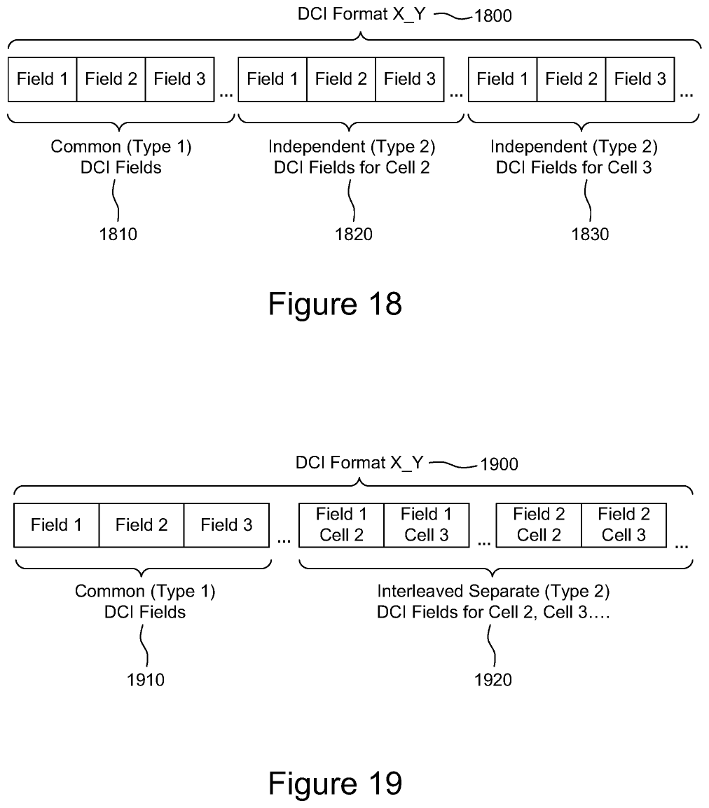

In another embodiment, a DCI format X_Y (It may be referred to as DCI Format X_Y where X=0 is for PUSCH scheduling, and X=1 is for PDSCH scheduling, and Y indicates the format number that may have values 3, 0a, 1a, 2a, or the like) (1800) for scheduling PUSCH/PDSCH on the plural cells is disclosed in FIG. 18. As shown therein Type 1 DCI fields may be grouped together (1810), and Type 2 DCI fields may be grouped according to the cell indices. For example, Type 2 DCI fields of cell index 2 (1820) are followed by Type 2 DCI fields of cell index 3 (1830), and so on. The grouping of Type 2 DCI fields (1820 and 1830) may start from the smallest cell index. The starting cell index is the smallest cell index among the co-scheduled cells. The cell indices of the co-scheduled cells may be contiguous or non-contiguous. A person of skill in the art will appreciate that the Type 1 or Type 2 DCI fields for PUSCH or PDSCH scheduling may include DCI fields categorized as Type 1 or Type 2 in other embodiments of the present disclosure. Further, Type 1 DCI field may include a CSCI field which may be configured as per the concepts described in conjunction with the description of the tables 1-5. The Type 2 DCI fields may be ordered in the same order of cell indices as indicated by a CSCI field in the DCI, the order of cell indices indicated by the CSCI field is described in conjunction with description of the tables 1-5.

In another embodiment, a DCI format X_Y (It may be referred to as DCI Format X_Y where X=0 is for PUSCH scheduling, and X=1 is for PDSCH scheduling, and Y indicates the format number that may have values 3, 0a, 1a, 2a, or the like) (1900) for scheduling PUSCH/PDSCH on the plural cells is disclosed in FIG. 19. As shown therein Type 1 DCI fields (1910) may be grouped together, and Type 2 DCI fields may be cell interleaved (1920), where field 1 may be grouped for all the co-scheduled cells followed by field 2 for all the co-scheduled cells, and so on. The interleaved Type 2 DCI fields may have a predefined order, for example, field 1 of cell index 2 is followed by field 1 of cell index 3, and so on, in an ascending order of cell indices. The cell index-based ordering may be done such that the combinations of cells with the smallest cell index may come first as compared to the others cell indices. The starting cell index is the smallest cell index among the co-scheduled cells. The cell indices of the co-scheduled cells may be contiguous or non-contiguous. For example, as shown in FIG. 19, for the co-scheduled cell indices of 2 and 3, Type 2 field 1 of cell index 2 is followed by Type 2 field 1 of cell index 3. A person of skill in the art will appreciate that the Type 1 or Type 2 DCI fields for PUSCH or PDSCH scheduling may include DCI fields categorized as Type 1 or Type 2 in other embodiments of the present disclosure. Further, Type 1 DCI field may include a CSCI field which may be configured as per the concepts described in conjunction with the description of the tables 1-5. The Type 2 DCI fields may be ordered in the same order of cell indices as indicated by a CSCI field in the DCI, the order of cell indices indicated by the CSCI field is described in conjunction with description of the tables 1-5.

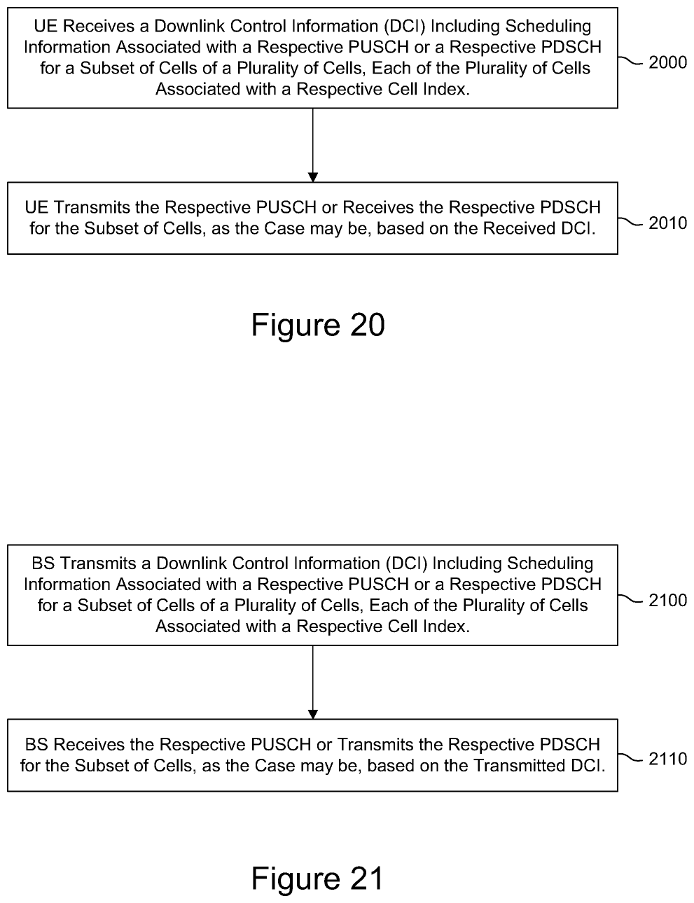

An example method performed by a user equipment according to an embodiment is shown in FIG. 20. According to this embodiment the method includes a step 2000 wherein a UE receives a downlink control information (DCI) including scheduling information associated with a respective PUSCH or a respective PDSCH for a subset of cells of a plurality of cells, each of the plurality of cells associated with a respective cell index. According to this embodiment the DCI includes a common field including information indicative of a first cell index associated with a first cell of the subset of cells and a second cell index associated with a second cell of the subset of cells, wherein either (i) the smallest of the first cell index or the second cell index is greater than smallest cell index of the plurality of the cells, or (ii) the first cell index and the second cell index are not consecutive cell indices. Further, according to this embodiment the DCI includes a first independent field including first information of a first category of information and a second independent field including second information of the first category of information, wherein the second independent field follows the first independent field in the DCI, wherein the first information is applicable to the cell having the smallest cell index of the subset of cells and wherein the second information is applicable to the scheduled cell having the second smallest cell index of the subset of cells. The method continues in a step 2010 wherein the UE transmits the respective PUSCH or receives the respective PDSCH on the subset of cells, as the case may be, based on the received DCI.

In an embodiment, the received DCI further comprises a third independent field including third information of a second category of information, and a fourth independent field including fourth information of the second category of information. The third independent field follows the second independent field in the DCI. The fourth independent field follows the third independent field in the DCI. The third information is applicable to the cell having the smallest cell index of the subset of cells and the fourth information is applicable to the cell having the second smallest cell index of the subset of cells.

In an embodiment, the received DCI further comprises a third independent field including third information of a second category of information and a fourth independent field including fourth information of the second category of information. The third independent field follows the first independent field in the DCI. The second independent field follows the third independent field in the DCI. The fourth independent field follows the second independent field in DCI. The third information is applicable to a cell having the smallest cell index of the subset of cells and the fourth information is applicable to the cell having the second smallest cell index of the subset of cells.

In an embodiment, the first common field in the received DCI further includes information indicative of a third cell index associated with a third cell of the subset of cells wherein the second cell index and the third cell index are consecutive, and the DCI further comprises a third independent field including third information of the first category of information. The third independent field follows the second independent field in the DCI and the third information is applicable to the scheduled cell having the third smallest cell index of the subset of cells.

In an embodiment, the received DCI further comprises a second common field including information applicable to the subset of cells of the plurality of cells. The information applicable to the subset of the plurality of cells includes one of DCI format information, downlink assignment index information, TPC for scheduled PUCCH information, PUCCH resource indicator information, or PDSCH-to-HARQ timing indicator information. When the information applicable to the subset of the plurality of cells includes DCI format information indicating uplink scheduling, the DCI further comprises a third common field carrying a TPC for scheduled PUCCH information and a fourth common field carrying a PUCCH resource indicator information.

In an embodiment, the first category of information in the received DCI includes one of new data indicator information, redundancy version information, modulation and coding scheme information, frequency domain resource assignment information, time domain resource assignment information, or HARQ process number information.

In an embodiment, the DCI is received on a cell other than one of the subset of cells.

In an embodiment, the DCI is received on the cell having the smallest cell index of the subset of cells.

In an embodiment, the method of wireless communication, performed by a UE, further comprising receiving a RRC signaling. The subset of cells is represented by two or more bits in the RRC signaling and the RRC signaling indicates a relationship between a value of the two or more bits and the subset of cells. The RRC signaling includes a Cell Group ID indicating the plurality of cells and further includes the respective cell indices for the plurality of cells. The DCI is received on a cell of the plurality of cells and the RRC signaling further includes the cell index of the cell of the plurality of cells upon which the DCI is received. The group of cells indicated by the Cell Group ID is a PUCCH cell group. The RRC signaling is included in a ServingCellConfig message.

An example method performed by a user equipment according to an embodiment is shown in FIG. 21. According to this embodiment the method includes a step 2010 wherein a BS transmits a downlink control information (DCI) including scheduling information associated with a respective PUSCH or a respective PDSCH for a subset of cells of a plurality of cells, each of the plurality of cells associated with a respective cell index. According to this embodiment the DCI includes a common field including information indicative of a first cell index associated with a first cell of the subset of cells and a second cell index associated with a second cell of the subset of cells, wherein either (i) the smallest of the first cell index or the second cell index is greater than smallest cell index of the plurality of the cells, or (ii) the first cell index and the second cell index are not consecutive cell indices. Further, according to this embodiment the DCI includes a first independent field including first information of a first category of information and a second independent field including second information of the first category of information, wherein the second independent field follows the first independent field in the DCI, wherein the first information is applicable to the cell having the smallest cell index of the subset of cells and wherein the second information is applicable to the scheduled cell having the second smallest cell index of the subset of cells. The method continues in a step 2110 wherein the BS receives the respective PUSCH or transmits the respective PDSCH on the subset of cells, as the case may be, based on the transmitted DCI.

In an embodiment, the transmitted DCI further comprises a third independent field including third information of a second category of information, and a fourth independent field including fourth information of the second category of information. The third independent field follows the second independent field in the DCI. The fourth independent field follows the third independent field in the DCI. The third information is applicable to the cell having the smallest cell index of the subset of cells and the fourth information is applicable to the cell having the second smallest cell index of the subset of cells.

In an embodiment, the transmitted DCI further comprises a third independent field including third information of a second category of information and a fourth independent field including fourth information of the second category of information. The third independent field follows the first independent field in the DCI. The second independent field follows the third independent field in the DCI. The fourth independent field follows the second independent field in DCI. The third information is applicable to a cell having the smallest cell index of the subset of cells and the fourth information is applicable to the cell having the second smallest cell index of the subset of cells.

In an embodiment, the first common field in the transmitted DCI further includes information indicative of a third cell index associated with a third cell of the subset of cells wherein the second cell index and the third cell index are consecutive, and the DCI further comprises a third independent field including third information of the first category of information. The third independent field follows the second independent field in the DCI and the third information is applicable to the scheduled cell having the third smallest cell index of the subset of cells.

In an embodiment, the transmitted DCI further comprises a second common field including information applicable to the subset of cells of the plurality of cells. The information applicable to the subset of the plurality of cells includes one of DCI format information, downlink assignment index information, TPC for scheduled PUCCH information, PUCCH resource indicator information, or PDSCH-to-HARQ timing indicator information. When the information applicable to the subset of the plurality of cells includes DCI format information indicating uplink scheduling, the DCI further comprises a third common field carrying a TPC for scheduled PUCCH information and a fourth common field carrying a PUCCH resource indicator information.

In an embodiment, the first category of information in the received DCI includes one of new data indicator information, redundancy version information, modulation and coding scheme information, frequency domain resource assignment information, time domain resource assignment information, or HARQ process number information.

In an embodiment, the DCI is transmitted on a cell other than one of the subset of cells.

In an embodiment, the DCI is transmitted on the cell having the smallest cell index of the subset of cells.

In an embodiment, the method of wireless communication, performed by a BS, further comprising transmitting a RRC signaling. The subset of cells is represented by two or more bits in the RRC signaling and the RRC signaling indicates a relationship between a value of the two or more bits and the subset of cells. The RRC signaling includes a Cell Group ID indicating the plurality of cells and further includes the respective cell indices for the plurality of cells. The DCI is received on a cell of the plurality of cells and the RRC signaling further includes the cell index of the cell of the plurality of cells upon which the DCI is transmitted. The group of cells indicated by the Cell Group ID is a PUCCH cell group. The RRC signaling is included in ServingCellConfig message.

### Same Transport Block (TB) on Co-Scheduled Cells

As shown in FIG. 11, scheduling PUSCH or PDSCH per cell on each of a plurality of cells (1140, 1150) with a single DCI (1100) transmitted on a scheduling cell (1130), where the plural PUSCH or PDSCH carry the same transport block (TB) (1110 and 1120), is shown in accordance with an embodiment.

A portion of TB (1110 or 1120) may be transmitted to each cell. The Code Block Groups (CBGs) of the TB may be divided among the scheduled cells for PUSCH/PDSCH transmission. The number of CBGs or the size of CBGs transmitted on each cell may be indicated separately to the UE via RRC signalling or the physical layer signalling.

In an embodiment, the size of CBGs transmitted on each cell may be configured as equal, in which case, no separate signalling may be required for configuring UE.

When the same transport block is transmitted/received on the co-scheduled cells, many data fields of the DCI format are common Type 1 DCI fields as they refer to the same PUSCH or PDSCH data.

A person of skill in the art will appreciate that the DCI fields for PUSCH or PDSCH scheduling same transport block (TB) on co-scheduled cells may include a CSCI field which may be configured as per the concepts described in conjunction with the tables 1-5. Further, DCI format described in conjunction with the FIGS. 6-8 may be used for scheduling same transport block (TB) on co-scheduled cells.

### PDSCH Scheduling DCI Fields

According to an embodiment, in a DCI format for PDSCH scheduling a plurality of cells, one or more of the DCI fields related to HARQ such as HARQ process number, DAI, PDSCH-to-HARQ feedback timing indicator, CBG transmission information (CBGTI), CBG flushing out information (CBGFI), One-shot HARQ-ACK request, PDSCH group index, new feedback indicator, Number of requested PDSCH group(s), etc. may be configured as Type 1 DCI fields among the cells. The DCI format indicator field and CSCI field may also be configured as Type 1 DCI fields among the scheduled cells.

In another embodiment, in a DCI format for PDSCH scheduling a plurality of cells, one or more of the DCI fields related to resource information such as TDRA, FDRA, Bandwidth part indicator, VRB-to-PRB mapping, PRB bundling size indicator, ZP CSI-RS trigger, Minimum applicable scheduling offset indicator, SCell dormancy indication, ChannelAccess-Cpext, may be configured as Type 1 DCI fields among the co-scheduled cells.

In another embodiment, in a DCI format for PDSCH scheduling a plurality of cells, one or more of the DCI fields related to transport block such as Modulation and coding scheme, new data indicator, Redundancy version, and Priority indicator may be configured as Type 2 DCI fields among the co-scheduled cells.

In another embodiment, in a DCI format for PDSCH scheduling a plurality of cells, one or more of the DCI fields related to the multi-antenna and power control may be configured as Type 2 DCI fields among the scheduled cells. For example, multi-antenna related fields such as DMRS sequence initialization, Antenna ports, Transmission configuration indication may be configured as Type 2 DCI fields among the scheduled cells while SRS request may be configured as Type 1 DCI field. Similarly, the TPC command for scheduled PUCCH and PUCCH resource indicator fields may be configured as Type 1 DCI fields among the co-scheduled cells.

### PUSCH Scheduling DCI Fields

Similarly, in accordance with an embodiment, in a DCI format for PUSCH scheduling a plurality of cells, one or more of the DCI fields related to HARQ such as HARQ process number, DAI (1^{st} and 2^{nd}), CBG transmission information (CBGTI), etc. may be configured as Type 1 DCI fields among the cells. The DCI format indicator field, CSCI field and DFI flag field may also be configured as Type 1 DCI fields among the co-scheduled cells.

In another embodiment, in a DCI format for PUSCH scheduling a plurality of cells, one or more of the DCI fields related to resource information such as TDRA, FDRA, Bandwidth part indicator, Frequency Hopping, ChannelAccess-Cpext, ChannelAccess-CPext-CAPC, Invalid symbol pattern indicator, Minimum applicable scheduling offset indicator, and SCell dormancy indication may be configured as Type 1 DCI fields among the co-scheduled cells.

In another embodiment, in a DCI format for PUSCH scheduling a plurality of cells, one or more of the DCI fields related to transport block such as Modulation and coding scheme, new data indicator, Redundancy version, UL-SCH indicator, and Priority indicator may be configured as Type 1 DCI fields among the co-scheduled cells.

In another embodiment, in a DCI format for PUSCH scheduling a plurality of cells, one or more of the DCI fields related to the multi-antenna and power-control may be configured as Type 2 DCI fields among the scheduled cells. For example, multi-antenna related fields such as DMRS sequence initialization, Antenna ports, Precoding information and number of layers, Second Precoding information, PTRS-DMRS association, Second PTRS-DMRS association, may be configured as Type 2 DCI fields among the scheduled cells while SRS request and CSI request may be configured as Type 1 DCI fields. Similarly, TPC command for scheduled PUSCH, Second TPC command for scheduled PUSCH, Open-loop power control parameter set indication, and beta_offset indicator fields may be configured as Type 2 DCI fields among the co-scheduled cells.

### Two Stage DCI

In accordance with an embodiment, once a UE is configured for PUSCH/PDSCH scheduling on a plurality of cells with a single DCI, a two-stage DCI may be configured, whereby in the first stage DCI a portion of DCI fields may be received by the UE and subsequently a second DCI may be received for the remaining DCI fields. This technique may help keep a check on the DCI size as an overly large DCI size could reduce the PDCCH reception probability. Also, it may be beneficial to have two-stage DCI as PDCCH size is restricted to 140 bits (excluding CRC) in 5G NR and PDCCH size might exceed 140 bits when scheduling plural cells using a single DCI.

In accordance with an embodiment, a way of scheduling multiple cells using a single DCI can includes the steps of:
receiving a first downlink control information (DCI) for scheduling a plurality of cells;
wherein the first DCI including one or more common fields applicable to the plurality of cells;
receiving a second downlink control information (DCI), after receiving the first DCI, for scheduling the plurality of cells;
wherein the second DCI includes at least one independent field applicable to each of the plurality of cells.

In an embodiment, the first stage DCI may contain the Type 1 DCI fields and the second stage DCI may contain the Type 2 DCI fields.

In another embodiment, the UE may be configured to receive the first stage DCI containing the Type 1 DCI fields and portion of Type 2 DCI fields to a total of 140 bits (excluding CRC) and the second stage DCI containing the remaining Type 2 DCI fields.

In another embodiment, if the first stage DCI contains only the Type 1 DCI fields, CSCI field may not be present in the DCI, while for the second stage DCI since all the Type 2 DCI fields are configured CSCI field may be present to indicate the scheduled cells.

In another embodiment, the first stage DCI information may be stored by UE for combining with the subsequently received one or more second stage DCI(s).

In another embodiment, a UE may be configured to receive the first stage DCI on PDCCH, and the second stage DCI on PDSCH. The second stage DCI may be multiplexed with the PDSCH scheduled by the first stage DCI.

In another embodiment, if the second stage DCI is configured to be received on PDSCH by a UE, the PDSCH may be configured to be received on the same scheduling cell on which PDCCH containing the first stage DCI was received.

In another embodiment, if the second stage DCI is configured to be received on PDSCH by a UE, the PDSCH may be configured to be received on a cell indicated by the cell indicator field of the first stage DCI.

In another embodiment, a UE may be configured to receive on a scheduling cell a first stage DCI containing a first indicator field, after receiving the first stage DCI, the UE may be configured to receive a second stage DCI containing a second indicator field. The first indicator field may indicate a cell on which the second stage DCI containing the second indicator field is received. The second indicator field may indicate a plurality of scheduled cells.

In another embodiment, a UE may be configured to receive on a scheduling cell a first stage DCI containing a first indicator field and a second indicator field, after receiving the first stage DCI, the UE may be configured to receive a second stage DCI. The first indicator field may indicate a cell on which the second stage DCI containing the second indicator field is received. The second indicator field may indicate a plurality of scheduled cells.

In another embodiment, a UE may be configured to receive on a first cell a first stage DCI, after receiving the first stage DCI, the UE may be configured to receive a second stage DCI on a second cell. The second cell may be indicated implicitly by the reception of first stage DCI or may be preconfigured in the UE by RRC signalling received from a base station. In another embodiment, the first cell and the second cell may be configured to be the same or different.

In another embodiment, a UE may be configured to dynamically receive a single-stage DCI and two-stage DCIs depending on the number of co-scheduled cells. For a larger number of co-scheduled cells, two-stage DCI may be used while for a small number of co-scheduled cells single stage DCI may be used. The switching between single-stage DCI and two-stage DCI may be indicated to UE by RRC signalling or physical layer signalling or may be determined by UE depending on the determination of the number of co-scheduled cells.

In another embodiment, the first stage DCI may be linked with the second stage DCI (if UE is configured to receive second stage DCI on PDCCH) to reduce the blind decoding effort by UE. The linkage information may be provided to UE by either RRC configuration or the first stage DCI. In another embodiment, the linkage information may indicate a predefined resource offset between the first PDCCH containing the first stage DCI and the second PDCCH containing the second stage DCI. The resource offset may indicate offset of time and/or frequency resources. In another embodiment, the linkage information may indicate same frequency resources and different time resources for receiving the first PDCCH containing the first stage DCI and the second PDCCH containing the second stage DCI.

A person of skill in the art will appreciate that the Type 1 or Type 2 DCI fields for PUSCH or PDSCH scheduling using two stage DCI may include DCI fields categorized as Type 1 or Type 2 in other embodiments of the present disclosure. Further, Type 1 DCI field may include a CSCI field which may be configured as per the concepts described in conjunction with the tables 1-5.

### Scheduling PUSCH or PDSCH Per Cell on Each of a Plurality of Cells in Case of Cell Release or Deactivation

In an embodiment, if a plurality of cells are semi-statically configured for various DCI fields and one or more cells goes to a dormant state or deactivated state or the cell(s) is/are released, the semi-static configuration of the DCI fields may be accordingly updated, and UE can continue to receive DCI scheduling a plurality of cells for the remaining cells in the cell group according to the updated semi-static configuration of the DCI fields.

In an alternative embodiment, if a plurality of cells are semi-statically configured for various DCI fields and one or more cells go to a dormant state or deactivated state or the cell(s) is/are released, the UE may release the semi-static configuration of the DCI fields and UE may no longer receive DCI scheduling a plurality of cells for the remaining cells in the cell group.

In another embodiment, if a plurality of cells are semi-statically configured for various DCI fields and one or more cells goes to a dormant state or deactivated state or the cell(s) is/are released, the semi-static configuration may be released, and UE may receive DCI scheduling a plurality of cells containing independent Type 2 DCI fields for each of the remaining cell(s) corresponding to the previously configured semi-static DCI fields while Type 1 DCI fields can continue to remain common for the cells.

### Switching Between Single Cell PUSCH or PDSCH Scheduling Mode and Plural Cell PUSCH or PDSCH Scheduling Mode

For simplicity, a UE may be configured in either a single cell PUSCH or PDSCH scheduling mode or plural cell PUSCH or PDSCH scheduling mode. Therefore, in accordance with an embodiment, a signalling mechanism may be used whereby a UE is configured to dynamically switch between single-cell PUSCH or PDSCH scheduling mode and plural cell PUSCH or PDSCH scheduling mode.

The switching configuration signalling can be provided by RRC signalling or a physical layer signalling. While switching from a plural cell PUSCH or PDSCH scheduling mode to a single cell PUSCH or PDSCH scheduling mode, the UE may save plural cell PUSCH or PDSCH scheduling configuration information which can be re-used when the UE switches back to a plural cell PUSCH or PDSCH scheduling mode from a single cell PUSCH or PDSCH scheduling mode.

Further, switching configuration signalling can include a duration or a predefined number of occasions for the switched mode to be valid before switching back to the previous mode. For example, if UE is in a single cell PUSCH or PDSCH scheduling mode, the UE can receive a switching configuration signalling indicating a duration or a predefined number of occasions for which the UE can switch to a plural cell PUSCH or PDSCH scheduling mode before switching back to single-cell PUSCH or PDSCH scheduling mode. It may help in getting the benefits of both modes.

In an embodiment, while in a plural cell PUSCH or PDSCH scheduling mode, if one or more cells goes to a dormant state or deactivated state or the cell(s) is/are released, UE can switch to a single cell PUSCH or PDSCH scheduling mode.

### Re-Transmission Scheduling

In accordance with an embodiment, a DCI for scheduling a plurality of cells may be used for scheduling the PUSCH or PDSCH, however, for re-transmissions, a UE may be configured by the base station to use a cell-specific single-cell DCI. In an alternative embodiment, a UE may be configured by the base station to use a DCI for scheduling a plurality of cells for both transmissions and re-transmissions, the Type 2 fields may indicate the cell-specific HARQ-ID, RV & NDI, etc. for scheduling re-transmissions.

### HARQ ACK/NACK Timing

In accordance with an embodiment the DCI format 1_Y for scheduling PDSCHs (for example, one of a DCI format among the DCI formats disclosed in FIGS. 12-19) may indicate a slot level offset in the PDSCH-to-HARQ_timing indicator DCI field for PUCCH transmission by the UE (for example, a UE described in conjunction with the description of FIG. 4).

If subslotLengthForPUCCH is not provided. The PUCCH timing may be according to the PDSCH-to-HARQ_timing indicator DCI field according to the following embodiments.

In an embodiment, the UE may be configured with same Time Domain Resource Allocation (TDRA) for all the co-scheduled cells (if the TDRA field is configured as a Type 1 DCI field or TDRA field is not included in a DCI and configured by RRC) and PDSCH reception and PDSCH-to-HARQ_timing may also be the same for all the co-scheduled cells. This embodiment may be beneficial in reducing the UE complexity at the expense of lesser scheduling flexibility among the co-scheduled cells. The co-scheduled cells may be configured as part of the same PUCCH group.

In another embodiment, the UE may be configured with different PDSCHs reception timings for the co-scheduled cells, one co-scheduled cell may be made a reference cell, and timing of the reference cell may be followed for determining the common PUCCH timing. The co-scheduled cells may be configured as part of the same PUCCH group. In another embodiment, the reference cell for determining the common PUCCH timing may be the cell with the earliest PDSCH start timing. In another embodiment, the reference cell for determining the common PUCCH timing may be the cell with the later PDSCH end timing among the co-scheduled cells. In another embodiment, the reference cell for determining the common PUCCH timing may be the cell configured in the UE by RRC signalling as the reference cell.

If subslotLengthForPUCCH is provided the PUCCH timing may be according to the following embodiments:

In another embodiment, if a UE is configured with subslotLengthForPUCCH in a PUCCH-Config of co-scheduled cells, the first symbol of a PUCCH resource provided by PUCCH-ResourceSet or SPS-PUCCH-AN-List in PUCCH-Config or by n1PUCCH-AN in SPS-Config, for multiplexing HARQ-ACK in a PUCCH transmission may be relative to the symbol of a reference cell. In another embodiment, the reference cell for determining the PUCCH transmission timing may be the cell configured with the maximum value for subslotLengthForPUCCH among the co-scheduled cells. In another embodiment, the reference cell for determining the PUCCH transmission timing may be the cell configured by RRC as the reference cell. In another embodiment, the reference cell for determining the PUCCH transmission timing may be the cell configured with the earliest PDSCH symbol among the co-scheduled cells. In another embodiment, the reference cell for determining the PUCCH transmission timing may be the cell configured with later PDSCH symbol among the co-scheduled cells.

### RELATED ART

(available at https://www.3gpp.org/ftp/TSG_RAN/WG1_RL1/TSGR1_109-e/Docs):
R1-2203135: Discussion on multi-cell PUSCH/PDSCH scheduling with a single scheduling DCI, Huawei, HiSilicon
R1-2203207: Discussion on Multi-cell PUSCH/PDSCH scheduling with a single DCI, ZTE
R1-2203346: Discussion on multi-cell PUSCH/PDSCH scheduling with a single DCI, Spreadtrum Communications
R1-2203448: Discussion on multi-cell PUSCH/PDSCH scheduling with a single DCI, CATT
R1-2203583: Discussion on multi-cell scheduling, vivo
R1-2203664: Discussion on multi-cell scheduling with a single DCI, China Telecom
R1-2203688: Discussion on Multi-cell PXSCH scheduling with a single DCI, NEC
R1-2203706: Discussion on multi-cell scheduling via a single DCI, Lenovo
R1-2203800: Discussion on the design of multi-cell scheduling with a single DCI, xiaomi
R1-2203842: Discussions on multi-cell PUSCH/PDSCH scheduling with a single DCI, Langbo
R1-2203925: Multi-cell PUSCH/PDSCH scheduling with a single DCI, Samsung
R1-2204026: Discussion on multi-cell PUSCH/PDSCH scheduling with a single DCI, OPPO
R1-2204087: Multi-cell scheduling with a single DCI, InterDigital, Inc.
R1-2204186: Discussion on multi-cell PUSCH/PDSCH scheduling with a single DCI, CAICT
R1-2204262: On multi-cell PUSCH/PDSCH scheduling with a single DCI, Apple
R1-2204324: Discussion on multi-cell PUSCH/PDSCH scheduling with a single DCI, CMCC
R1-2204398: Discussion on multi-cell PUSCH/PDSCH scheduling with a single DCI, NTT DOCOMO, INC.
R1-2204631: Discussion on Multi-cell PUSCH/PDSCH scheduling with a single DCI, LG Electronics
R1-2204697: On multi-cell PUSCH/PDSCH scheduling with a single DCI, MediaTek Inc.
R1-2204816: Discussions on multi-cell scheduling with a single DCI, Intel Corporation
R1-2204865: Multi-cell PUSCH/PDSCH scheduling with a single DCI, Charter Communications
R1-2204888: Multi-cell PUSCH/PDSCH scheduling with a single DCI, Ericsson
R1-2205051: Multi-cell PUSCH and PDSCH scheduling with a single DCI, Qualcomm Incorporated
R1-2205073: Discussion on Multicarrier scheduling with a single DCI, FGI
R1-2205088: Consideration on multi-cell PUSCH/PDSCH scheduling with a single DCI, Fujitsu Limited
R1-2203276: On multi-cell PUSCH/PDSCH scheduling with a single DCI, Nokia, Nokia Shanghai Bell
R1-2205234: Feature lead summary #1 on multi-cell PUSCH/PDSCH scheduling with a single DCI, Moderator (Lenovo)
R1-2205235: Feature lead summary #2 on multi-cell PUSCH/PDSCH scheduling with a single DCI, Moderator (Lenovo)
R1-2205236: Feature lead summary #3 on multi-cell PUSCH/PDSCH scheduling with a single DCI, Moderator (Lenovo)
R1-2205486, Feature lead summary #4 on multi-cell PUSCH/PDSCH scheduling with a single DCI, Moderator (Lenovo)
R1-2205487: Feature lead summary #5 on multi-cell PUSCH/PDSCH scheduling with a single DCI, Moderator (Lenovo)

1.-30. (canceled)

31. A method performed by a user equipment comprising: receiving a downlink control information (DCI) including scheduling information associated with a respective PUSCH or a respective PDSCH for a subset of cells of a plurality of cells, each of the plurality of cells associated with a respective cell index;
wherein the DCI comprises: a common field including information indicative of a first cell index associated with a first cell of the subset of cells and a second cell index associated with a second cell of the subset of cells, wherein either (i) the smallest of the first cell index or the second cell index is greater than smallest cell index of the plurality of the cells, or (ii) the first cell index and the second cell index are not consecutive cell indices; a first independent field including first information of a first category of information; and
a second independent field including second information of the first category of information;
wherein the second independent field follows the first independent field in the DCI;
wherein the first information is applicable to the cell having the smallest cell index of the subset of cells; and
wherein the second information is applicable to the cell having the second smallest cell index of the subset of cells; and transmitting the respective PUSCH on the subset of cells or receiving the respective PDSCH on the subset of cells based on the received DCI.

32. The method of claim 31, wherein the DCI further comprises: a third independent field including third information of a second category of information;
a fourth independent field including fourth information of the second category of information; wherein the third independent field follows the second independent field in the DCI;
wherein the fourth independent field follows the third independent field in the DCI;
wherein the third information is applicable to the cell having the smallest cell index of the subset of cells; and wherein the fourth information is applicable to the scheduled cell having the second smallest cell index of the subset of cells.

33. The method of claim 31, wherein the first common field further includes information indicative of a third cell index associated with a third cell of the subset of cells wherein the second cell index and the third cell index are consecutive;
and the DCI further comprises a third independent field including third information of the first category of information;
wherein the third independent field follows the second independent field in the DCI; and
wherein the third information is applicable to the cell having the third smallest cell index of the subset of cells.

34. The method of claim 31, wherein the DCI further comprises a second common field including information applicable to the subset of cells of the plurality of cells; and
wherein the information applicable to the subset of the plurality of cells includes one of
DCI format information, downlink assignment index information, TPC for scheduled PUCCH information, PUCCH resource indicator information, or PDSCH-to-HARQ timing indicator information.

35. The method of claim 34, wherein when information applicable to the subset of the plurality of cells includes DCI format information indicating uplink scheduling, the DCI further comprises: a third common field carrying a TPC for scheduled PUCCH information; and a fourth common field carrying a PUCCH resource indicator information.

36. The method of claim 31, wherein the first category of information includes one of new data indicator information, redundancy version information, modulation and coding scheme information, frequency domain resource assignment information, time domain resource assignment information, or HARQ process number information.

37. The method of claim 31, wherein the DCI is received on a cell other than one of the subset of cells, or the DCI is received on the cell having the smallest cell index of the subset of cells.

38. The method of claim 31, further comprising:
receiving a RRC signaling;
wherein the subset of cells is represented by two or more bits in the RRC signaling; and
wherein the RRC signaling indicates a relationship between a value of the two or more bits and the subset of cells; and
wherein the RRC signaling includes a Cell Group ID indicating the plurality of cells and further includes the respective cell indices for the plurality of cells.

39. The method of claim 38, wherein the DCI is received on a cell of the plurality of cells and the RRC signaling further includes the cell index of the cell of the plurality of cells upon which the DCI is received.

40. The method of claim 38, wherein the group of cells indicated by the Cell Group ID is a PUCCH cell group.

41. An apparatus comprising: a processor or a plurality of processors; a transceiver or a plurality of transceivers configured to receive, from a base station, a downlink control information (DCI) including scheduling information associated with a respective PUSCH or a respective PDSCH for a subset of cells of a plurality of cells using the processor or the plurality of processors, each of the plurality of cells associated with a respective cell index;
wherein the DCI comprises: a common field including information indicative of a first cell index associated with a first cell of the subset of cells and a second cell index associated with a second cell of the subset of cells, wherein either (i) the smallest of the first cell index or the second cell index is greater than smallest cell index of the plurality of the cells, or (ii) the first cell index and the second cell index are not consecutive cell indices;
a first independent field including first information of a first category of information; and a second independent field including second information of the first category of information;
wherein the second independent field follows the first independent field in the DCI;
wherein the first information is applicable to the cell having the smallest cell index of the subset of cells; and
wherein the second information is applicable to the cell having the second smallest cell index of the subset of cells; and the transceiver or the plurality of transceivers configured to transmit the respective PUSCH on the subset of cells or receive the respective PDSCH on the subset of cells based on the received DCI.

42. The apparatus of claim 41, wherein the DCI further comprises: a third independent field including third information of a second category of information; a fourth independent field including fourth information of the second category of information; wherein the third independent field follows the second independent field in the DCI; wherein the fourth independent field follows the third independent field in the DCI; wherein the third information is applicable to the cell having the smallest cell index of the subset of cells; and wherein the fourth information is applicable to the cell having the second smallest cell index of the subset of cells.

43. The apparatus of claim 41, wherein the first common field further includes information indicative of a third cell index associated with a third cell of the subset of cells wherein the second cell index and the third cell index are consecutive;
and the DCI further comprises a third independent field including third information of the first category of information; wherein the third independent field follows the second independent field in the DCI; and wherein the third information is applicable to the cell having the third smallest cell index of the subset of cells.

44. The apparatus of claim 41, wherein the DCI further comprises a second common field including information applicable to the subset of cells of the plurality of cells; and
wherein the information applicable to the subset of the plurality of cells includes one of DCI format information, downlink assignment index information, TPC for scheduled PUCCH information, PUCCH resource indicator information, or PDSCH-to-HARQ timing indicator information.

45. The apparatus of claim 44, wherein when information applicable to the subset of the plurality of cells includes DCI format information indicating uplink scheduling, the DCI further comprises: a third common field carrying a TPC for scheduled PUCCH information; and a fourth common field carrying a PUCCH resource indicator information.

46. The apparatus of claim 41, wherein the first category of information includes one of new data indicator information, redundancy version information, modulation and coding scheme information, frequency domain resource assignment information, time domain resource assignment information, or HARQ process number information.

47. The apparatus of claim 41, wherein the DCI is received on a cell other than one of the subset of cells, or wherein the DCI is received on the cell having the smallest cell index of the subset of cells.

48. The apparatus of claim 41, further comprising: the transceiver or the plurality of transceivers configured to receive a RRC signaling;
wherein the subset of cells is represented by two or more bits in the RRC signaling; and
wherein the RRC signaling indicates a relationship between a value of the two or more bits and the subset of cells; and
wherein the RRC signaling includes a Cell Group ID indicating the plurality of cells and further includes the respective cell indices for the plurality of cells.

49. The apparatus of claim 48, wherein the DCI is received on a cell of the plurality of cells and the RRC signaling further includes the cell index of the cell of the plurality of cells upon which the DCI is received.

50. The apparatus of claim 48, wherein the group of cells indicated by the Cell Group ID is a PUCCH cell group.
